(19) United States
(12) Patent Application Publication
(10) Pub. No.: US 2024/0405290 A1
(43) Pub. Date: Dec. 5, 2024

(54) SECONDARY BATTERY, BATTERY PACK, ELECTRONIC EQUIPMENT, ELECTRIC TOOL, ELECTRIC AIRCRAFT, AND ELECTRIC VEHICLE

(71) Applicant: MURATA MANUFACTURING CO., LTD., Kyoto (JP)

(72) Inventors: Mana YAMASAKI, Kyoto (JP); Osamu NAGANUMA, Kyoto (JP)

(21) Appl. No.: 18/647,680

(22) Filed: Apr. 26, 2024

Related U.S. Application Data
(63) Continuation of application No. PCT/JP2022/042587, filed on Nov. 16, 2022.

(30) Foreign Application Priority Data
Nov. 18, 2021 (JP) 2021-187685

(51) Int. Cl. H01M 10/0587; B64D 27/357; H01M 4/13; H01M 4/36; H01M 4/62; H01M 50/417; H01M 50/46; H01M 50/466; H01M 50/489

(52) U.S. Cl. CPC H01M 10/0587; B64D 27/357; H01M 4/13; H01M 4/366; H01M 4/62; H01M 50/417; H01M 50/461; H01M 50/466; H01M 50/489; B64D 2221/00; H01M 2220/20; H01M 2220/30

(57) ABSTRACT

A secondary battery includes an electrode wound body including a stacked structure wound around a central axis extending in a first direction. The stacked structure includes a positive electrode and a negative electrode that are stacked with a separator interposed therebetween. The separator includes a stacked part in which three or more bases are stacked. At least two of the three or more bases are folded back in a center region of the electrode wound body. The center region of the electrode wound body is a region located on an inner winding side relative to an inner winding side end part of a negative electrode current collector. In the electrode wound body, an inner winding side edge of the positive electrode, the negative electrode, and the stacked part overlap each other.

### CROSS-REFERENCE TO RELATED APPLICATIONS

The present application is a continuation of PCT patent application No. PCT/JP2022/042587, filed on Nov. 16, 2022, which claims priority to Japanese patent application No. 2021-187685, filed on Nov. 18, 2021, the entire contents of which are incorporated herein by reference.

### BACKGROUND

The present disclosure relates to a secondary battery, and to a battery pack, electronic equipment, an electric tool, an electric aircraft, and an electric vehicle that each include the secondary battery.

Various kinds of electronic equipment, including mobile phones, have been widely used. Such widespread use has promoted development of a secondary battery as a power source that is smaller in size and lighter in weight and allows for a higher energy density. The secondary battery includes a positive electrode, a negative electrode, and an electrolyte that are contained inside an outer package member. A configuration of the secondary battery has been considered in various ways.

A secondary battery is proposed in which what is called a tabless structure is employed to reduce an internal resistance and to allow for charging and discharging with a relatively large current.

### SUMMARY

A secondary battery according to an embodiment of the present disclosure includes an electrode wound body, a positive electrode current collector plate, a negative electrode current collector plate, an electrolytic solution, and a battery can. The electrode wound body includes a stacked structure wound around a central axis extending in a first direction. The stacked structure includes a positive electrode and a negative electrode that are stacked with a separator interposed therebetween. The positive electrode current collector plate faces a first end face of the electrode wound body, the first end face being in the first direction. The negative electrode current collector plate faces a second end face of the electrode wound body. The second end face is opposite to the first end face in the first direction. The battery can contains the electrode wound body, the positive electrode current collector plate, the negative electrode current collector plate, and the electrolytic solution. The positive electrode includes a positive electrode covered part in which a positive electrode current collector is covered with a positive electrode active material layer, and a positive electrode exposed part in which the positive electrode current collector is not covered with the positive electrode active material layer and is exposed. The positive electrode exposed part is joined to the positive electrode current collector plate. The negative electrode includes a negative electrode covered part in which a negative electrode current collector is covered with a negative electrode active material layer, and a negative electrode exposed part in which the negative electrode current collector is not covered with the negative electrode active material layer and is exposed. The negative electrode exposed part is joined to the negative electrode current collector plate. The separator includes a stacked part in which three or more bases are stacked. At least two of the three or more bases are folded back in a center region of the electrode wound body. The center region of the electrode wound body is a region located on an inner winding side relative to an inner winding side end part of the negative electrode current collector. In the electrode wound body, an inner winding side edge of the positive electrode, the negative electrode, and the stacked part overlap each other.

A battery pack according to an embodiment of the present disclosure includes a secondary battery, a controller configured to control the secondary battery, and an outer package body containing the secondary battery. The secondary battery includes an electrode wound body, a positive electrode current collector plate, a negative electrode current collector plate, an electrolytic solution, and a battery can. The electrode wound body includes a stacked structure wound around a central axis extending in a first direction. The stacked structure includes a positive electrode and a negative electrode that are stacked with a separator interposed therebetween. The positive electrode current collector plate faces a first end face of the electrode wound body, the first end face being in the first direction. The negative electrode current collector plate faces a second end face of the electrode wound body. The second end face is opposite to the first end face in the first direction. The battery can contains the electrode wound body, the positive electrode current collector plate, the negative electrode current collector plate, and the electrolytic solution. The positive electrode includes a positive electrode covered part in which a positive electrode current collector is covered with a positive electrode active material layer, and a positive electrode exposed part in which the positive electrode current collector is not covered with the positive electrode active material layer and is exposed. The positive electrode exposed part is joined to the positive electrode current collector plate. The negative electrode includes a negative electrode covered part in which a negative electrode current collector is covered with a negative electrode active material layer, and a negative electrode exposed part in which the negative electrode current collector is not covered with the negative electrode active material layer and is exposed. The negative electrode exposed part is joined to the negative electrode current collector plate. The separator includes a stacked part in which three or more bases are stacked. At least two of the three or more bases are folded back in a center region of the electrode wound body. The center region of the electrode wound body is a region located on an inner winding side relative to an inner winding side end part of the negative electrode current collector. In the electrode wound body, an inner winding side edge of the positive electrode, the negative electrode, and the stacked part overlap each other.

An electric vehicle according to an embodiment of the present disclosure includes a secondary battery, a converter, a drive unit, and a controller. The secondary battery includes an electrode wound body, a positive electrode current collector plate, a negative electrode current collector plate, an electrolytic solution, and a battery can. The electrode wound body includes a stacked structure wound around a central axis extending in a first direction. The stacked structure includes a positive electrode and a negative electrode that are stacked with a separator interposed therebetween. The positive electrode current collector plate faces a first end face of the electrode wound body, the first end face being in the first direction. The negative electrode current collector plate faces a second end face of the electrode wound body. The second end face is opposite to the first end face in the first direction. The battery can contains the electrode wound body, the positive electrode current collector plate, the negative electrode current collector plate, and the electrolytic solution. The positive electrode includes a positive electrode covered part in which a positive electrode current collector is covered with a positive electrode active material layer, and a positive electrode exposed part in which the positive electrode current collector is not covered with the positive electrode active material layer and is exposed. The positive electrode exposed part is joined to the positive electrode current collector plate. The negative electrode includes a negative electrode covered part in which a negative electrode current collector is covered with a negative electrode active material layer, and a negative electrode exposed part in which the negative electrode current collector is not covered with the negative electrode active material layer and is exposed. The negative electrode exposed part is joined to the negative electrode current collector plate. The separator includes a stacked part in which three or more bases are stacked. At least two of the three or more bases are folded back in a center region of the electrode wound body. The center region of the electrode wound body is a region located on an inner winding side relative to an inner winding side end part of the negative electrode current collector. In the electrode wound body, an inner winding side edge of the positive electrode, the negative electrode, and the stacked part overlap each other. The converter is configured to convert electric power suppled from the secondary battery into a driving force. The drive unit is configured to perform driving in accordance with the driving force. The controller is configured to control operation of the secondary battery.

An electric aircraft according to an embodiment of the present disclosure includes a battery pack, a plurality of rotary wings, a motor, a support shaft, a motor controller, and an electric power supply line. The battery pack includes a secondary battery, a controller configured to control the secondary battery, and an outer package body containing the secondary battery. The secondary battery includes an electrode wound body, a positive electrode current collector plate, a negative electrode current collector plate, an electrolytic solution, and a battery can. The electrode wound body includes a stacked structure wound around a central axis extending in a first direction. The stacked structure includes a positive electrode and a negative electrode that are stacked with a separator interposed therebetween. The positive electrode current collector plate faces a first end face of the electrode wound body, the first end face being in the first direction. The negative electrode current collector plate faces a second end face of the electrode wound body. The second end face is opposite to the first end face in the first direction. The battery can contains the electrode wound body, the positive electrode current collector plate, the negative electrode current collector plate, and the electrolytic solution. The positive electrode includes a positive electrode covered part in which a positive electrode current collector is covered with a positive electrode active material layer, and a positive electrode exposed part in which the positive electrode current collector is not covered with the positive electrode active material layer and is exposed. The positive electrode exposed part is joined to the positive electrode current collector plate. The negative electrode includes a negative electrode covered part in which a negative electrode current collector is covered with a negative electrode active material layer, and a negative electrode exposed part in which the negative electrode current collector is not covered with the negative electrode active material layer and is exposed. The negative electrode exposed part is joined to the negative electrode current collector plate. The separator includes a stacked part in which three or more bases are stacked. At least two of the three or more bases are folded back in a center region of the electrode wound body. The center region of the electrode wound body is a region located on an inner winding side relative to an inner winding side end part of the negative electrode current collector. In the electrode wound body, an inner winding side edge of the positive electrode, the negative electrode, and the stacked part overlap each other. The motor is configured to rotate each of the rotary wings. The support shaft supports each of the rotary wings and the motor. The motor controller is configured to control rotation of the motor. The electric power supply line is configured to supply electric power to the motor. The battery pack is coupled to the electric power supply line.

An electric tool according to an embodiment of the present disclosure includes a secondary battery and a movable unit. The secondary battery includes an electrode wound body, a positive electrode current collector plate, a negative electrode current collector plate, an electrolytic solution, and a battery can. The electrode wound body includes a stacked structure wound around a central axis extending in a first direction. The stacked structure includes a positive electrode and a negative electrode that are stacked with a separator interposed therebetween. The positive electrode current collector plate faces a first end face of the electrode wound body, the first end face being in the first direction. The negative electrode current collector plate faces a second end face of the electrode wound body. The second end face is opposite to the first end face in the first direction. The battery can contains the electrode wound body, the positive electrode current collector plate, the negative electrode current collector plate, and the electrolytic solution. The positive electrode includes a positive electrode covered part in which a positive electrode current collector is covered with a positive electrode active material layer, and a positive electrode exposed part in which the positive electrode current collector is not covered with the positive electrode active material layer and is exposed. The positive electrode exposed part is joined to the positive electrode current collector plate. The negative electrode includes a negative electrode covered part in which a negative electrode current collector is covered with a negative electrode active material layer, and a negative electrode exposed part in which the negative electrode current collector is not covered with the negative electrode active material layer and is exposed. The negative electrode exposed part is joined to the negative electrode current collector plate. The separator includes a stacked part in which three or more bases are stacked. At least two of the three or more bases are folded back in a center region of the electrode wound body. The center region of the electrode wound body is a region located on an inner winding side relative to an inner winding side end part of the negative electrode current collector. In the electrode wound body, an inner winding side edge of the positive electrode, the negative electrode, and the stacked part overlap each other. The movable unit is configured to receive electric power from the secondary battery.

Electronic equipment according to an embodiment of the present disclosure includes a secondary battery as an electric power supply source. The secondary battery includes an electrode wound body, a positive electrode current collector plate, a negative electrode current collector plate, an electrolytic solution, and a battery can. The electrode wound body includes a stacked structure wound around a central axis extending in a first direction. The stacked structure includes a positive electrode and a negative electrode that are stacked with a separator interposed therebetween. The positive electrode current collector plate faces a first end face of the electrode wound body, the first end face being in the first direction. The negative electrode current collector plate faces a second end face of the electrode wound body. The second end face is opposite to the first end face in the first direction. The battery can contains the electrode wound body, the positive electrode current collector plate, the negative electrode current collector plate, and the electrolytic solution. The positive electrode includes a positive electrode covered part in which a positive electrode current collector is covered with a positive electrode active material layer, and a positive electrode exposed part in which the positive electrode current collector is not covered with the positive electrode active material layer and is exposed. The positive electrode exposed part is joined to the positive electrode current collector plate. The negative electrode includes a negative electrode covered part in which a negative electrode current collector is covered with a negative electrode active material layer, and a negative electrode exposed part in which the negative electrode current collector is not covered with the negative electrode active material layer and is exposed. The negative electrode exposed part is joined to the negative electrode current collector plate. The separator includes a stacked part in which three or more bases are stacked. At least two of the three or more bases are folded back in a center region of the electrode wound body. The center region of the electrode wound body is a region located on an inner winding side relative to an inner winding side end part of the negative electrode current collector. In the electrode wound body, an inner winding side edge of the positive electrode, the negative electrode, and the stacked part overlap each other.

### BRIEF DESCRIPTION OF THE DRAWINGS

The accompanying drawings are included to provide a further understanding of the present disclosure, and are incorporated in and constitute a part of this specification. The drawings illustrate embodiments and, together with the specification, serve to explain the principles of the present disclosure.

FIG. 1 is a sectional view of a configuration of a secondary battery according to an example embodiment of the present disclosure.

FIG. 2 is a schematic diagram illustrating a configuration example of a stacked structure including a positive electrode, a negative electrode, and a separator illustrated in FIG. 1.

FIG. 3A is a sectional diagram illustrating a configuration example of a sectional structure of an electrode wound body illustrated in FIG. 1.

FIG. 3B is an enlarged sectional diagram illustrating a part of the electrode wound body illustrated in FIG. 3A in an enlarged manner.

FIG. 4A is a developed view of the positive electrode illustrated in FIG. 1.

FIG. 4B is a sectional view of the positive electrode illustrated in FIG. 1.

FIG. 5A is a developed view of the negative electrode illustrated in FIG. 1.

FIG. 5B is a sectional view of the negative electrode illustrated in FIG. 1.

FIG. 6A is a plan view of a positive electrode current collector plate illustrated in FIG. 1.

FIG. 6B is a plan view of a negative electrode current collector plate illustrated in FIG. 1.

FIG. 7 is an enlarged schematic view of a vicinity of a center of the electrode wound body illustrated in FIG. 1.

FIG. 8 is a perspective diagram describing a process of manufacturing the secondary battery illustrated in FIG. 1.

FIG. 9 is a block diagram illustrating a circuit configuration of a battery pack to which the secondary battery according to an example embodiment of the present disclosure is applied.

FIG. 10 is a schematic diagram illustrating a configuration of an electric tool to which the secondary battery according to an example embodiment of the present disclosure is applicable.

FIG. 11 is a schematic diagram illustrating a configuration of an unmanned aircraft to which the secondary battery according to an example embodiment of the present disclosure is applicable.

FIG. 12 is a schematic diagram illustrating a configuration of a power storage system for an electric vehicle to which the secondary battery according to an example embodiment of the present disclosure is applied.

FIG. 13 is an enlarged schematic view of a vicinity of a center of an electrode wound body of Comparative example 1-1.

FIG. 14 is an enlarged schematic view of a vicinity of a center of an electrode wound body of Comparative example 1-2.

### DETAILED DESCRIPTION

Consideration has been given in various ways to improve performance of a secondary battery. However, there is still room for improvement in performance of the secondary battery.

It is desirable to provide a secondary battery having higher reliability.

In the following, the present disclosure is described in further detail including with reference to the accompanying drawings. Note that the following description is directed to illustrative examples of the present disclosure and not to be construed as limiting to the present disclosure. Factors including, without limitation, numerical values, shapes, materials, components, positions of the components, and how the components are coupled to each other are illustrative only and not to be construed as limiting to the present disclosure. Further, elements in the following example embodiments which are not recited in a most-generic independent claim of the present disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the present disclosure are unillustrated in the drawings.

A description is given first of a secondary battery according to an example embodiment of the present disclosure.

In the present example embodiment, a cylindrical lithium-ion secondary battery having an outer appearance of a cylindrical shape will be described as an example. However, the secondary battery of an embodiment of the present disclosure is not limited to the cylindrical lithium-ion secondary battery, and may be a lithium-ion secondary battery having an outer appearance of a shape other than the cylindrical shape, or may be a battery in which an electrode reactant other than lithium is used.

Although a charge and discharge principle of the secondary battery is not particularly limited, the following description deals with a case where a battery capacity is obtained through insertion and extraction of the electrode reactant. The secondary battery includes a positive electrode, a negative electrode, and an electrolyte. In the secondary battery, to prevent precipitation of the electrode reactant on a surface of the negative electrode during charging, a charge capacity of the negative electrode is greater than a discharge capacity of the positive electrode. For example, an electrochemical capacity per unit area of the negative electrode is set to be greater than an electrochemical capacity per unit area of the positive electrode.

The electrode reactant is not particularly limited in kind, as described above. For example, the electrode reactant may be a light metal such as an alkali metal or an alkaline earth metal. Non-limiting examples of the alkali metal include lithium, sodium, and potassium. Non-limiting examples of the alkaline earth metal include beryllium, magnesium, and calcium.

In the following, described as an example is a case where the electrode reactant is lithium. A secondary battery in which the battery capacity is obtained through insertion and extraction of lithium is what is called a lithium-ion secondary battery. In the lithium-ion secondary battery, lithium is inserted and extracted in an ionic state.

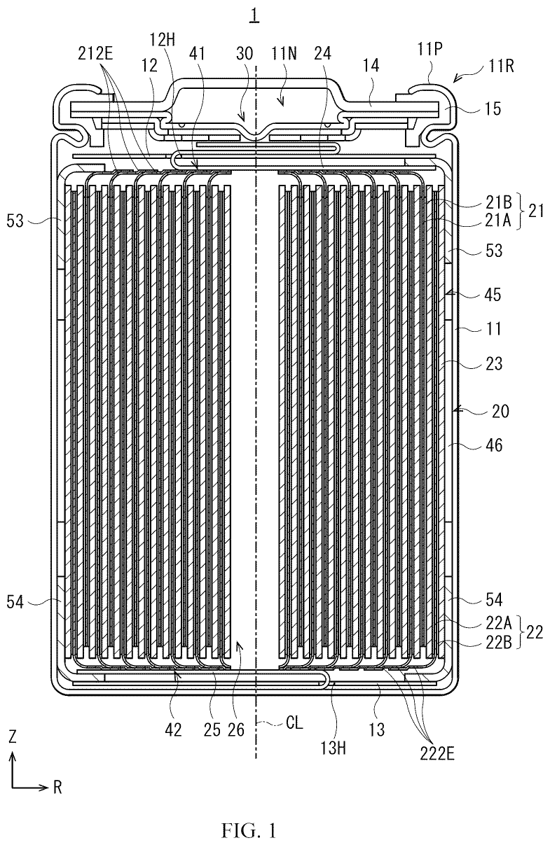

FIG. 1 illustrates a sectional configuration of a lithium-ion secondary battery 1 (hereinafter simply referred to as a secondary battery 1) according to the present example embodiment along a height direction. In the secondary battery 1 illustrated in FIG. 1, an electrode wound body 20 as a battery device is contained inside an outer package can 11 having a cylindrical shape.

For example, the secondary battery 1 includes, inside the outer package can 11, a pair of insulating plates 12 and 13 and the electrode wound body 20. The electrode wound body 20 is a structure in which a positive electrode 21 and a negative electrode 22 are stacked with a separator 23 interposed therebetween and are wound, for example. The electrode wound body 20 is impregnated with an electrolytic solution. The electrolytic solution is a liquid electrolyte. Note that the secondary battery 1 may further include at least one of a thermosensitive resistive device (a PTC device) or a reinforcing member inside the outer package can 11.

The outer package can 11 has, for example, a hollow cylindrical structure having an upper end part and a lower end part in a Z-axis direction. The Z-axis direction is the height direction. The lower end part is closed, and the upper end part is open. The upper end part of the outer package can 11 is thus an open end part 11N. A constituent material of the outer package can 11 includes, for example, a metal material such as iron. Note that a surface of the outer package can 11 may be plated with, for example, a metal material such as nickel. The insulating plate 12 and the insulating plate 13 are so opposed to each other as to allow the electrode wound body 20 to be interposed therebetween in the Z-axis direction, for example. Note that in the present specification, the open end part 11N and a vicinity thereof in the Z-axis direction may be referred to as an upper part of the secondary battery 1, and a region where the outer package can 11 is closed and a vicinity thereof in the Z-axis direction may be referred to as a lower part of the secondary battery 1.

Each of the insulating plates 12 and 13 is, for example, a dish-shaped plate having a surface perpendicular to a winding axis of the electrode wound body 20, that is, a surface perpendicular to a Z-axis in FIG. 1. The insulating plates 12 and 13 are so disposed as to allow the electrode wound body 20 to be interposed therebetween.

For example, a structure in which a battery cover 14 and a safety valve mechanism 30 are crimped with a gasket 15 interposed therebetween, that is, a crimped structure 11R, is provided at the open end part 11N of the outer package can 11. The outer package can 11 is sealed by the battery cover 14, with the electrode wound body 20 and other components being contained inside the outer package can 11. The crimped structure 11R is what is called a crimp structure, and has a bent part 11P serving as what is called a crimp part.

The battery cover 14 is a closing member that closes the open end part 11N of the outer package can 11 in a state where the electrode wound body 20 and other components are contained inside the outer package can 11, for example. The battery cover 14 includes a material similar to the material included in the outer package can 11, for example. A middle region of the battery cover 14 protrudes upward, i.e., in a +Z direction. As a result, a peripheral region, i.e., a region other than the middle region, of the battery cover 14 is in a state of being in contact with the safety valve mechanism 30, for example.

The gasket 15 is a sealing member interposed between the bent part 11P of the outer package can 11 and the battery cover 14, for example. The gasket 15 seals a gap between the bent part 11P and the battery cover 14. Note that a surface of the gasket 15 may be coated with, for example, asphalt. The gasket 15 includes any one or more of insulating materials, for example. The insulating material is not particularly limited in kind, and non-limiting examples thereof include a polymer material such as polybutylene terephthalate (PBT) or polypropylene (PP). In an example embodiment, the insulating material is polybutylene terephthalate. A reason for this is to sufficiently seal the gap between the bent part 11P and the battery cover 14, with the outer package can 11 and the battery cover 14 being electrically separated from each other.

The safety valve mechanism 30 is adapted to cancel the sealed state of the outer package can 11 to thereby release a pressure inside the outer package can 11, i.e., an internal pressure of the outer package can 11 on an as-needed basis upon an increase in the internal pressure, for example. Examples of a cause of the increase in the internal pressure of the outer package can 11 include a gas generated due to a decomposition reaction of the electrolytic solution upon charging and discharging. The internal pressure of the outer package can 11 can also increase due to heating from outside.

The electrode wound body 20 is a power generation device that causes charging and discharging reactions to proceed, and is contained inside the outer package can 11. The electrode wound body 20 includes the positive electrode 21, the negative electrode 22, the separator 23, and the electrolytic solution, i.e., a liquid electrolyte.

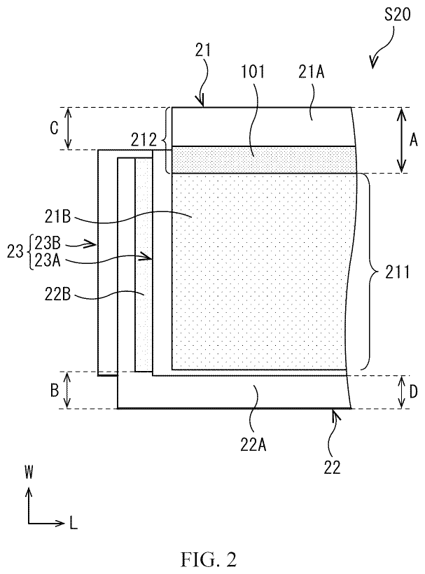

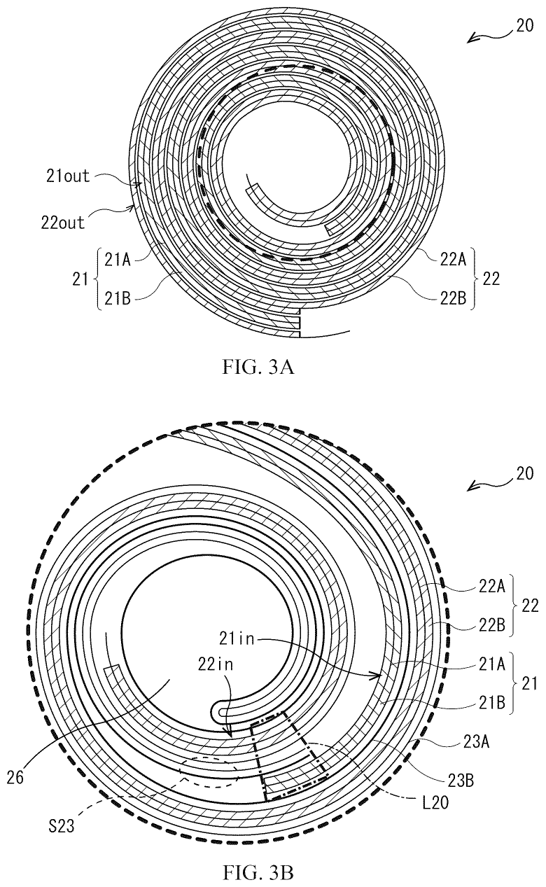

FIG. 2 is a developed view of the electrode wound body 20, and schematically illustrates a part of a stacked structure S20 including the positive electrode 21, the negative electrode 22, and the separator 23. In the electrode wound body 20, the positive electrode 21 and the negative electrode 22 are stacked on each other with the separator 23 interposed therebetween. The separator 23 includes, for example, two bases, that is, a first separator member 23A and a second separator member 23B. Accordingly, the electrode wound body 20 includes the four-layer stacked structure S20 in which the positive electrode 21, the first separator member 23A, the negative electrode 22, and the second separator member 23B are stacked in order. Each of the positive electrode 21, the first separator member 23A, the negative electrode 22, and the second separator member 23B is a substantially band-shaped member in which a W-axis direction is a lateral direction and an L-axis direction is a longitudinal direction. As illustrated in FIG. 3A, the electrode wound body 20 results from the stacked structure S20 being so wound around a central axis CL (see FIG. 1) extending in the Z-axis direction as to form a spiral shape in a horizontal section orthogonal to the Z-axis direction. Here, the stacked structure S20 is wound in an orientation in which the W-axis direction substantially coincides with the Z-axis direction. Note that FIG. 3A illustrates a configuration example of the electrode wound body 20 along the horizontal section orthogonal to the Z-axis direction. To secure visibility, however, FIG. 3A omits illustration of the separator 23. FIG. 3B illustrates an enlarged view of a region encircled with a dashed line in FIG. 3A. The electrode wound body 20 has an outer appearance of a substantially circular columnar shape as a whole. The positive electrode 21 and the negative electrode 22 are wound, remaining in a state of being opposed to each other with the separator 23 interposed therebetween. The electrode wound body 20 has a through hole 26 as an internal space at a center thereof. The through hole 26 is a hole into which a winding core for assembling the electrode wound body 20 and an electrode rod for welding are each to be put.

The positive electrode 21, the negative electrode 22, and the separator 23 are so wound that the separator 23 is located in each of an outermost wind of the electrode wound body 20 and an innermost wind of the electrode wound body 20. Further, in the outermost wind of the electrode wound body 20, the negative electrode 22 is located on an outer side relative to the positive electrode 21. For example, as illustrated in FIG. 3A, an outermost positive electrode wind part 21out located in an outermost wind of the positive electrode 21 included in the electrode wound body 20 is located on an inner side relative to an outermost negative electrode wind part 22out located in an outermost wind of the negative electrode 22 included in the electrode wound body 20. Here, the outermost positive electrode wind part 21out is a part corresponding to the outermost one wind of the positive electrode 21 in the electrode wound body 20. The outermost negative electrode wind part 22out is a part corresponding to the outermost one wind of the negative electrode 22 in the electrode wound body 20. In contrast, in the innermost wind of the electrode wound body 20, the negative electrode 22 is located on the inner side relative to the positive electrode 21. For example, as illustrated in FIG. 3B, an innermost negative electrode wind part 22 in located in an innermost wind of the negative electrode 22 included in the electrode wound body 20 is located on the inner side relative to an innermost positive electrode wind part 21 in located in an innermost wind of the positive electrode 21 included in the electrode wound body 20. Here, the innermost positive electrode wind part 2lin is a part corresponding to the innermost one wind of the positive electrode 21 in the electrode wound body 20. The innermost negative electrode wind part 22 in is a part corresponding to the innermost one wind of the negative electrode 22 in the electrode wound body 20. The number of winds of each of the positive electrode 21, the negative electrode 22, and the separator 23 is not particularly limited, and may be chosen as desired.

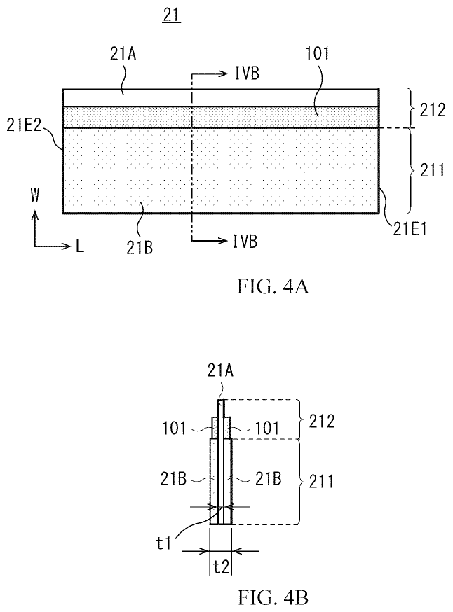

FIG. 4A is a developed view of the positive electrode 21, and schematically illustrates a state before being wound. FIG. 4B illustrates a sectional configuration of the positive electrode 21. Note that FIG. 4B illustrates a section as viewed in an arrowed direction along line IVB-IVB illustrated in FIG. 4A. The positive electrode 21 includes, for example, a positive electrode current collector 21A, and a positive electrode active material layer 21B provided on the positive electrode current collector 21A. The positive electrode active material layer 21B may be provided only on one surface of the positive electrode current collector 21A, or may be provided on each of both surfaces of the positive electrode current collector 21A, for example. FIG. 4B illustrates a case where the positive electrode active material layer 21B is provided on each of both surfaces of the positive electrode current collector 21A.

The positive electrode 21 includes a positive electrode covered part 211 in which the positive electrode current collector 21A is covered with the positive electrode active material layer 21B, and a positive electrode exposed part 212 in which the positive electrode current collector 21A is not covered with the positive electrode active material layer 21B and is exposed. As illustrated in FIG. 4A, the positive electrode covered part 211 and the positive electrode exposed part 212 each extend along the L-axis direction, i.e., the longitudinal direction, from an outer winding side edge 21E1 to an inner winding side edge 21E2 of the positive electrode 21 in the electrode wound body 20. Here, the L-axis direction corresponds to a winding direction of the electrode wound body 20. Thus, in the positive electrode 21, the positive electrode current collector 21A is covered with the positive electrode active material layer 21B from the outer winding side edge 21E1 to the inner winding side edge 21E2 of the positive electrode 21 in the winding direction of the electrode wound body 20. The positive electrode covered part 211 and the positive electrode exposed part 212 are adjacent to each other in the W-axis direction, i.e., the lateral direction. Note that the positive electrode exposed part 212 is coupled to the positive electrode current collector plate 24, as illustrated in FIG. 1. In an example embodiment, an insulating layer 101 is provided in the vicinity of a border between the positive electrode covered part 211 and the positive electrode exposed part 212. In an example embodiment, as with the positive electrode covered part 211 and the positive electrode exposed part 212, the insulating layer 101 also extends from an innermost winding side end part to an outermost winding side end part of the electrode wound body 20. Further, in an example embodiment,, the insulating layer 101 is adhered to the first separator member 23A, the second separator member 23B, or both. A reason for this is that this makes it possible to prevent the positive electrode 21 and the separator 23 from becoming misaligned with each other. Further, in an example embodiment, the insulating layer 101 includes a resin including polyvinylidene difluoride (PVDF). A reason for this is that when the insulating layer 101 includes PVDF, the insulating layer 101 is swollen by, for example, a solvent included in the electrolytic solution, which makes it possible for the insulating layer 101 to be favorably adhered to the separator 23. A detailed configuration of the positive electrode 21 will be described later.

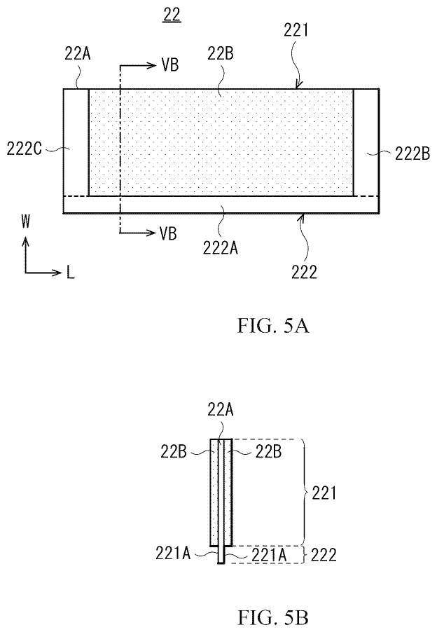

FIG. 5A is a developed view of the negative electrode 22, and schematically illustrates a state before being wound. FIG. 5B illustrates a sectional configuration of the negative electrode 22. Note that FIG. 5B illustrates a section as viewed in an arrowed direction along line VB-VB illustrated in FIG. 5A. The negative electrode 22 includes, for example, a negative electrode current collector 22A, and a negative electrode active material layer 22B provided on the negative electrode current collector 22A. The negative electrode active material layer 22B may be provided only on one surface of the negative electrode current collector 22A, or may be provided on each of both surfaces of the negative electrode current collector 22A, for example. FIG. 5B illustrates a case where the negative electrode active material layer 22B is provided on each of both surfaces of the negative electrode current collector 22A.

The negative electrode 22 includes a negative electrode covered part 221 in which the negative electrode current collector 22A is covered with the negative electrode active material layer 22B, and a negative electrode exposed part 222 in which the negative electrode current collector 22A is not covered with the negative electrode active material layer 22B and is exposed. As illustrated in FIG. 5A, the negative electrode covered part 221 and the negative electrode exposed part 222 each extend along the L-axis direction, i.e., the longitudinal direction. The negative electrode exposed part 222 extends from the innermost winding side end part to the outermost winding side end part of the electrode wound body 20. In contrast, the negative electrode covered part 221 is provided at neither the innermost winding side end part of the electrode wound body 20 nor the outermost winding side end part of the electrode wound body 20. As illustrated in FIG. 5A, portions of the negative electrode exposed part 222 are provided to sandwich the negative electrode covered part 221 in the L-axis direction, i.e., the longitudinal direction. For example, the negative electrode exposed part 222 includes a first part 222A, a second part 222B, and a third part 222C. The first part 222A is provided to be adjacent to the negative electrode covered part 221 in the W-axis direction, and extends in the L-axis direction from the innermost winding side end part to the outermost winding side end part of the electrode wound body 20. The second part 222B and the third part 222C are provided to sandwich the negative electrode covered part 221 in the L-axis direction. For example, the second part 222B is located in the vicinity of the innermost winding side end part of the electrode wound body 20, and the third part 222C is located in the vicinity of the outermost winding side end part of the electrode wound body 20. Note that as illustrated in FIG. 1, the first part 222A of the negative electrode exposed part 222 is coupled to the negative electrode current collector plate 25. A detailed configuration of the negative electrode 22 will be described later.

In the secondary battery 1, the stacked structure S20 of the electrode wound body 20 includes the positive electrode 21 and the negative electrode 22 that are so stacked with the separator 23 interposed therebetween that the positive electrode exposed part 212 and the first part 222A of the negative electrode exposed part 222 face toward mutually opposite directions along the W-axis direction, i.e., a width direction. In the electrode wound body 20, an end part of the separator 23 is fixed by attaching a fixing tape 46 to a side surface part 45 of the electrode wound body 20 to thereby prevent loosening of winding.

In an example embodiment, as illustrated in FIG. 2, the secondary battery 1 satisfies A>B, where A is a width of the positive electrode exposed part 212, and B is a width of the first part 222A of the negative electrode exposed part 222. For example, when the width A is 7 (mm), the width B is 4 (mm). Further, in an example embodiment, the secondary battery 1 satisfies C>D, where C is a width of a portion of the positive electrode exposed part 212 protruding from an outer edge in the width direction of the separator 23, and D is a protruding length, of the first part 222A of the negative electrode exposed part 222, from an opposite outer edge in the width direction of the separator 23. For example, when the width C is 4.5 (mm), the length D is 3 (mm).

As illustrated in FIG. 1, in the upper part of the secondary battery 1, first edge parts 212E, of the positive electrode exposed part 212 wound around the central axis CL, that are adjacent to each other in a radial direction (an R direction) of the electrode wound body 20 are so bent toward the central axis CL as to overlap each other. Similarly, in the lower part of the secondary battery 1, second edge parts 222E, of the negative electrode exposed part 222 wound around the central axis CL, that are adjacent to each other in the radial direction (the R direction) are so bent toward the central axis CL as to overlap each other. Accordingly, the first edge parts 212E of the positive electrode exposed part 212 gather at an end face 41 in the upper part of the electrode wound body 20, and the second edge parts 222E of the negative electrode exposed part 222 gather at an end face 42 in the lower part of the electrode wound body 20. To achieve better contact between the positive electrode current collector plate 24 for extracting a current and the first edge parts 212E, the first edge parts 212E bent toward the central axis CL form a flat surface. Similarly, to achieve better contact between the negative electrode current collector plate 25 for extracting a current and the second edge parts 222E, the second edge parts 222E bent toward the central axis CL form a flat surface. Note that as used herein, the term “flat surface” encompasses not only a completely flat surface but also a surface having some asperities or surface roughness to the extent that joining of the positive electrode exposed part 212 to the positive electrode current collector plate 24 and joining of the negative electrode exposed part 222 to the negative electrode current collector plate 25 are possible.

The positive electrode current collector 21A includes an aluminum foil, for example, as will be described later. The negative electrode current collector 22A includes a copper foil, for example, as will be described later. In this case, the positive electrode current collector 21A is softer than the negative electrode current collector 22A. In other words, the positive electrode exposed part 212 has a Young's modulus lower than a Young's modulus of the negative electrode exposed part 222. Accordingly, in an example embodiment, the secondary battery 1 satisfies A>B and C>D. In such a case, when the positive electrode exposed part 212 and the negative electrode exposed part 222 are simultaneously bent with equal pressures from both electrode sides, the bent portion in the positive electrode 21 and the bent portion in the negative electrode 22 sometimes become equal in height measured from an end of the separator 23. At this time, the first edge parts 212E (FIG. 1) of the positive electrode exposed part 212 appropriately overlap each other by being bent. This allows for easy joining of the positive electrode exposed part 212 and the positive electrode current collector plate 24 to each other. Similarly, the second edge parts 222E (FIG. 1) of the negative electrode exposed part 222 appropriately overlap each other by being bent. This allows for easy joining of the negative electrode exposed part 222 and the negative electrode current collector plate 25 to each other. As used herein, the term “joining” refers to coupling by, for example, laser welding; however, a method of joining is not limited to laser welding.

As illustrated in FIG. 2, a portion, of the positive electrode exposed part 212 of the positive electrode 21, that is opposed to the negative electrode 22 with the separator 23 interposed therebetween is covered with the insulating layer 101. The insulating layer 101 has a width of, for example, 3 mm in the W-axis direction. The insulating layer 101 entirely covers a region of the positive electrode exposed part 212 of the positive electrode 21 that is opposed to the negative electrode covered part 221 of the negative electrode 22 with the separator 23 interposed therebetween. The insulating layer 101 makes it possible to effectively prevent an internal short circuit of the secondary battery 1 when foreign matter enters between the negative electrode covered part 221 and the positive electrode exposed part 212, for example. Further, when the secondary battery 1 undergoes an impact, the insulating layer 101 absorbs the impact, thereby making it possible to effectively prevent bending of the positive electrode exposed part 212 and a short circuit between the positive electrode exposed part 212 and the negative electrode 22.

The secondary battery 1 may further include insulating tapes 53 and 54 in a gap between the outer package can 11 and the electrode wound body 20. The positive electrode exposed part 212 having portions gathering at the end face 41 and the negative electrode exposed part 222 having portions gathering at the end face 42 are conductors, such as metal foils, that are exposed. Accordingly, if the positive electrode exposed part 212 and the negative electrode exposed part 222 are in close proximity to the outer package can 11, a short circuit between the positive electrode 21 and the negative electrode 22 can occur via the outer package can 11. A short circuit can also occur when the positive electrode current collector plate 24 on the end face 41 and the outer package can 11 come into close proximity to each other. To address this, in an example embodiment, the insulating tapes 53 and 54 are provided as insulating members. Each of the insulating tapes 53 and 54 is an adhesive tape including a base layer, and an adhesive layer provided on one surface of the base layer. The base layer includes, for example, any one of polypropylene, polyethylene terephthalate, or polyimide. To prevent the provision of the insulating tapes 53 and 54 from resulting in a decreased capacity of the electrode wound body 20, the insulating tapes 53 and 54 are disposed not to overlap the fixing tape 46 attached to the side surface part 45, and each have a thickness set to be less than or equal to a thickness of the fixing tape 46.

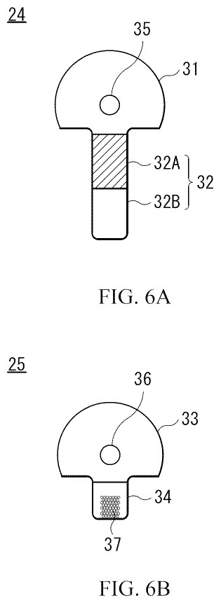

In a typical lithium-ion secondary battery, for example, a lead for current extraction is welded to one location on each of the positive electrode and the negative electrode. However, this increases an internal resistance of the lithium-ion secondary battery and causes the lithium-ion secondary battery to generate heat to become hot upon discharging; therefore, such a configuration is unsuitable for high-rate discharging. To address this, in the secondary battery 1 according to the present example embodiment, the positive electrode current collector plate 24 is disposed on the end face 41, and the negative electrode current collector plate 25 is disposed on the end face 42. In addition, the positive electrode exposed part 212 and the positive electrode current collector plate 24 that are located at the end face 41 are welded to each other at multiple points; and the negative electrode exposed part 222 and the negative electrode current collector plate 25 that are located at the end face 42 are welded to each other at multiple points. A reduced internal resistance of the secondary battery 1 is thereby achieved. Each of the end faces 41 and 42 being a flat surface as described above also contributes to the reduced resistance. The positive electrode current collector plate 24 is electrically coupled to the battery cover 14 via the safety valve mechanism 30, for example. The negative electrode current collector plate 25 is electrically coupled to the outer package can 11, for example. FIG. 6A is a schematic diagram illustrating a configuration example of the positive electrode current collector plate 24. FIG. 6B is a schematic diagram illustrating a configuration example of the negative electrode current collector plate 25. The positive electrode current collector plate 24 is a metal plate including, for example, a simple substance or a composite material of aluminum or an aluminum alloy. The negative electrode current collector plate 25 is a metal plate including, for example, a simple substance of nickel, a nickel alloy, copper, or a copper alloy, or a composite material of two or more thereof.

As illustrated in FIG. 6A, the positive electrode current collector plate 24 has a shape in which a band-shaped part 32 having a substantially rectangular shape is coupled to a fan-shaped part 31 having a substantially fan shape. The fan-shaped part 31 has a through hole 35 in the vicinity of a middle thereof. In the secondary battery 1, the positive electrode current collector plate 24 is provided to allow the through hole 35 to overlap the through hole 26 in the Z-axis direction. A hatched portion in FIG. 6A represents an insulating part 32A of the band-shaped part 32. The insulating part 32A is a portion of the band-shaped part 32 and has an insulating tape attached thereto or an insulating material applied thereto. Of the band-shaped part 32, a portion below the insulating part 32A is a coupling part 32B to be coupled to a sealing plate that also serves as an external terminal. Note that when the secondary battery 1 has a battery structure without a metallic center pin in the through hole 26 as illustrated in FIG. 1, there is a low possibility that the band-shaped part 32 will come into contact with a region of a negative electrode potential. In such a case, the positive electrode current collector plate 24 does not have to include the insulating part 32A. When the positive electrode current collector plate 24 does not include the insulating part 32A, it is possible to increase a width of each of the positive electrode 21 and the negative electrode 22 by an amount corresponding to a thickness of the insulating part 32A to thereby increase a charge and discharge capacity.

The negative electrode current collector plate 25 illustrated in FIG. 6B has a shape substantially the same as the shape of the positive electrode current collector plate 24 illustrated in FIG. 6A. However, the negative electrode current collector plate 25 includes a band-shaped part 34 different from the band-shaped part 32 of the positive electrode current collector plate 24. The band-shaped part 34 of the negative electrode current collector plate 25 is shorter than the band-shaped part 32 of the positive electrode current collector plate 24, and includes no portion corresponding to the insulating part 32A of the positive electrode current collector plate 24. The band-shaped part 34 is provided with projections 37 of circular shape that are depicted as multiple circles. Upon resistance welding, a current is concentrated on the projections 37, causing the projections 37 to melt to cause the band-shaped part 34 to be welded to a bottom of the outer package can 11. As with the positive electrode current collector plate 24, the negative electrode current collector plate 25 has a through hole 36 in the vicinity of a middle of a fan-shaped part 33. In the secondary battery 1, the negative electrode current collector plate 25 is provided to allow the through hole 36 to overlap the through hole 26 in the Z-axis direction.

The fan-shaped part 31 of the positive electrode current collector plate 24 covers only a portion of the end face 41, owing to a plan shape of the fan-shaped part 31. Similarly, the fan-shaped part 33 of the negative electrode current collector plate 25 covers only a portion of the end face 42, owing to a plan shape of the fan-shaped part 33. Reasons why the fan-shaped parts 31 and 33 do not respectively cover the entire end faces 41 and 42 include the following two reasons, for example. A first reason is to allow the electrolytic solution to smoothly permeate the electrode wound body 20 in assembling the secondary battery 1, for example. A second reason is to allow a gas generated when the lithium-ion secondary battery comes into an abnormally hot state or an overcharged state to be easily released to the outside.

The positive electrode current collector 21A includes, for example, an electrically conductive material such as aluminum. The positive electrode current collector 21A is a metal foil including aluminum or an aluminum alloy, for example.

The positive electrode active material layer 21B includes, as a positive electrode active material, any one or more of positive electrode materials into which lithium is insertable and from which lithium is extractable. Note that the positive electrode active material layer 21B may further include any one or more of other materials including, without limitation, a positive electrode binder and a positive electrode conductor. In an example embodiment, the positive electrode material is a lithium-containing compound. The lithium-containing compound may be a lithium-containing composite oxide or a lithium-containing phosphoric acid compound, for example. The lithium-containing composite oxide is an oxide including lithium and one or more of other elements, that is, one or more of elements other than lithium, as constituent elements. The lithium-containing composite oxide has any of crystal structures including, without limitation, a layered rock-salt crystal structure and a spinel crystal structure, for example. The lithium-containing phosphoric acid compound is a phosphoric acid compound including lithium and one or more of other elements as constituent elements, and has a crystal structure such as an olivine crystal structure, for example. In an example embodiment, the positive electrode active material layer 21B includes, as the positive electrode active material, at least one of lithium cobalt oxide, lithium nickel cobalt manganese oxide, or lithium nickel cobalt aluminum oxide. The positive electrode binder includes, for example, any one or more of materials including, without limitation, a synthetic rubber and a polymer compound. Non-limiting examples of the synthetic rubber include a styrene-butadiene-based rubber, a fluorine-based rubber, and ethylene propylene diene. Non-limiting examples of the polymer compound include polyvinylidene difluoride and polyimide. The positive electrode conductor includes, for example, any one or more of materials including, without limitation, a carbon material. Non-limiting examples of the carbon material include graphite, carbon black, acetylene black, and Ketjen black. Note that the positive electrode conductor may be any of electrically conductive materials, and may be, for example, a metal material or an electrically conductive polymer.

Further, in an example embodiment, the positive electrode active material layer 21B includes a fluorine compound and a nitrogen compound. For example, a positive electrode film including the fluorine compound and the nitrogen compound may be provided on a surface of the positive electrode active material layer 21B. In addition, in an example embodiment, a weight ratio F/N of a fluorine content to a nitrogen content in the positive electrode film of the positive electrode active material layer 21B is within a range from 3 to 50 both inclusive. For example, the weight ratio F/N of the fluorine content to the nitrogen content in the positive electrode film of the positive electrode active material layer 21B may be within a range from 15 to 35 both inclusive. Note that the weight ratio F/N of the fluorine content to the nitrogen content in the positive electrode film of the positive electrode active material layer 21B is calculable based on, for example, a spectral peak area of a 1s orbital of a nitrogen atom and a spectral peak area of a 1s orbital of a fluorine atom that are measurable by X-ray photoelectron spectroscopy.

Further, in an example embodiment, the positive electrode active material layer 21B has an area density within a range from 21.5 mg/cm² to 23.5 mg/cm² both inclusive. A reason for this is that this allows for suppression of an increase in temperature of the secondary battery 1 at the time of high load rate charging. Further, in an example embodiment, as illustrated in FIG. 4B, a ratio t2/t1 of a thickness t2 of the positive electrode covered part 211, that is, a total thickness t2 of the positive electrode current collector 21A and the positive electrode active material layer 21B, to a thickness t1 of the positive electrode current collector 21A is within a range from 5.0 to 6.5 both inclusive. Here, the thickness t2 of the positive electrode covered part 211 of the positive electrode 21 is within a range from 60 μm to 90 μm both inclusive, for example. The thickness t1 of the positive electrode current collector 21A is within a range from 6 μm to 15 μm both inclusive, for example.

The negative electrode current collector 22A includes, for example, an electrically conductive material such as copper. The negative electrode current collector 22A is a metal foil including, for example, nickel, a nickel alloy, copper, or a copper alloy. In an example embodiment, a surface of the negative electrode current collector 22A is roughened. A reason for this is to improve adherence of the negative electrode active material layer 22B to the negative electrode current collector 22A owing to what is called an anchor effect. In this case, the surface of the negative electrode current collector 22A is to be roughened at least in a region opposed to the negative electrode active material layer 22B. Non-limiting examples of a roughening method include a method in which microparticles are formed through an electrolytic treatment. In the electrolytic treatment, the microparticles are formed on the surface of the negative electrode current collector 22A by an electrolytic method in an electrolyzer. This provides the surface of the negative electrode current collector 22A with asperities. A copper foil produced by the electrolytic method is generally called an electrolytic copper foil.

The negative electrode active material layer 22B includes, as a negative electrode active material, any one or more of negative electrode materials into which lithium is insertable and from which lithium is extractable. Note that the negative electrode active material layer 22B may further include any one or more of other materials including, without limitation, a negative electrode binder and a negative electrode conductor. The negative electrode material is a carbon material, for example. A reason for this is that the carbon material exhibits very little change in crystal structure at the time of insertion and extraction of lithium, and a high energy density is thus obtainable stably. Another reason is that the carbon material also serves as a negative electrode conductor, which allows for improvement in electrical conductivity of the negative electrode active material layer 22B. The carbon material may be, for example, graphitizable carbon, non-graphitizable carbon, or graphite. In an example embodiment, spacing of a (002) plane of the non-graphitizable carbon is 0.37 nm or more. In an example embodiment, spacing of a (002) plane of the graphite is 0.34 nm or less. Non-limiting examples of the carbon material include pyrolytic carbons, cokes, glassy carbon fibers, an organic polymer compound fired body, activated carbon, and carbon blacks. Non-limiting examples of the cokes include pitch coke, needle coke, and petroleum coke. The organic polymer compound fired body is a resultant of firing or carbonizing a polymer compound such as a phenol resin or a furan resin at a suitable temperature. Other than the above, the carbon material may be low-crystalline carbon heat-treated at a temperature of about 1000° C. or lower, or may be amorphous carbon, for example. Note that the carbon material may have any of a fibrous shape, a spherical shape, a granular shape, and a flaky shape. In the secondary battery 1, when an open-circuit voltage in a fully charged state, that is, a battery voltage, is 4.25 V or higher, the amount of extracted lithium per unit mass increases as compared with when the open-circuit voltage in the fully charged state is 4.20 V, even with the same positive electrode active material. The amount of the positive electrode active material and the amount of the negative electrode active material are therefore adjusted accordingly. This makes it possible to obtain a high energy density.

The negative electrode active material layer 22B may include, as the negative electrode active material, a silicon-containing material including at least one of silicon, silicon oxide, a carbon-silicon compound, or a silicon alloy. The term “silicon-containing material” is a generic term for a material that includes silicon as a constituent element. Note that the silicon-containing material may include only silicon as the constituent element. Only one kind of silicon-containing material may be used, or two or more kinds of silicon-containing materials may be used. The silicon-containing material is able to form an alloy with lithium, and may be a simple substance of silicon, a silicon alloy, a silicon compound, a mixture of two or more thereof, or a material including one or more phases thereof. Further, the silicon-containing material may be crystalline or amorphous, or may include both a crystalline portion and an amorphous portion. Note that the simple substance described here refers to a simple substance merely in a general sense. The simple substance may thus include a small amount of impurity. In other words, purity of the simple substance is not limited to 100%. The silicon alloy includes, as one or more constituent elements other than silicon, any one or more of elements including, without limitation, tin, nickel, copper, iron, cobalt, manganese, zinc, indium, silver, titanium, germanium, bismuth, antimony, and chromium, for example. The silicon compound includes, as one or more constituent elements other than silicon, any one or more of elements including, without limitation, carbon and oxygen, for example. Note that the silicon compound may include, as one or more constituent elements other than silicon, any one or more of the series of constituent elements described above in relation to the silicon alloy, for example. Non-limiting examples of the silicon alloy and the silicon compound include SiB₄, SiB₆, Mg₂Si, Ni₂Si, TiSi₂, MoSi₂, CoSi₂, NiSi₂, CaSi₂, CrSi₂, Cu₅Si, FeSi₂, MnSi₂, NbSi₂, TaSi₂, VSi₂, WSi₂, ZnSi₂, SiC, Si₃N₄, Si₂N₂O, and SiOᵥ (where 0<v≤2). Note that the range of v may be chosen as desired, and may be, for example, 0.2<v<1.4.

Further, in an example embodiment, the negative electrode active material layer 22B includes a fluorine compound and a nitrogen compound. For example, a negative electrode film including the fluorine compound and the nitrogen compound may be provided on a surface of the negative electrode active material layer 22B. In addition, in an example embodiment, the weight ratio F/N of a fluorine content to a nitrogen content in the negative electrode film of the negative electrode active material layer 22B is within a range from 1 to 30 both inclusive. For example, the weight ratio F/N of the fluorine content to the nitrogen content in the negative electrode film of the negative electrode active material layer 22B may be within a range from 5 to 15 both inclusive. Note that the weight ratio F/N of the fluorine content to the nitrogen content in the negative electrode film of the negative electrode active material layer 22B is calculable based on, for example, the spectral peak area of the 1s orbital of the nitrogen atom and the spectral peak area of the 1s orbital of the fluorine atom that are measurable by X-ray photoelectron spectroscopy.

The separator 23 is interposed between the positive electrode 21 and the negative electrode 22. The separator 23 allows lithium ions to pass through and prevents a short circuit of a current caused by contact between the positive electrode 21 and the negative electrode 22. The separator 23 includes, for example, any one or more kinds of porous films each including, for example, a synthetic resin or a ceramic, and may be a stacked film including two or more kinds of porous films. Non-limiting examples of the synthetic resin include polytetrafluoroethylene, polypropylene, and polyethylene. In an example embodiment, the separator 23 may include the bases that include a single-layer polyolefin porous film including polyethylene. A reason for this is that a favorable high output power characteristic is obtainable as compared with a stacked film. In an example embodiment, when the first separator member 23A and the second separator member 23B included in the separator 23 each include a single-layer porous film including polyolefin, the porous film may have a thickness within a range from 10 μm to 15 μm both inclusive, for example. The porous film may have a surface density within a range from, for example, 6.3 g/m² to 8.3 g/m² both inclusive. For example, the separator 23 may include a porous film as each of the above-described bases, and a polymer compound layer provided on one of or each of both surfaces of each of the bases. A reason for this is that adherence of the separator 23 to each of the positive electrode 21 and the negative electrode 22 improves, which suppresses distortion of the electrode wound body 20. As a result, a decomposition reaction of the electrolytic solution is suppressed, and leakage of the electrolytic solution with which the bases are impregnated is also suppressed. This prevents resistance from easily increasing even upon repeated charging and discharging, and also suppresses swelling of the secondary battery. The polymer compound layer includes a polymer compound such as polyvinylidene difluoride. A reason for this is that the polymer compound such as polyvinylidene difluoride has superior physical strength and is electrochemically stable. Note that the polymer compound may be other than polyvinylidene difluoride. To form the polymer compound layer, for example, a solution in which the polymer compound is dissolved in a solvent such as an organic solvent is applied on the base, following which the base is dried. Alternatively, the base may be immersed in the solution and thereafter dried. The polymer compound layer may include any one or more kinds of insulating particles such as inorganic particles, for example. Non-limiting examples of the kind of the inorganic particles include aluminum oxide and aluminum nitride.

The electrolytic solution includes a solvent and an electrolyte salt. Note that the electrolytic solution may further include any one or more of other materials. Non-limiting examples of the other materials include an additive. The solvent includes any one or more of nonaqueous solvents including, without limitation, an organic solvent. An electrolytic solution including a nonaqueous solvent is what is called a nonaqueous electrolytic solution. The nonaqueous solvent includes a fluorine compound and a dinitrile compound, for example. The fluorine compound includes, for example, at least one of fluorinated ethylene carbonate, trifluorocarbonate, trifluoroethyl methyl carbonate, a fluorinated carboxylic acid ester, or a fluorine ether. The nonaqueous solvent may further include a nitrile compound other than the dinitrile compound, such as at least one of a mononitrile compound or a trinitrile compound. In an example embodiment, the dinitrile compound may be succinonitrile (SN). However, the dinitrile compound is not limited to succinonitrile, and may be another dinitrile compound such as adiponitrile.

The electrolyte salt includes, for example, any one or more of salts including, without limitation, a lithium salt. Note that the electrolyte salt may include a salt other than the lithium salt, for example. Non-limiting examples of the salt other than the lithium salt include a salt of a light metal other than lithium. Non-limiting examples of the lithium salt include lithium hexafluorophosphate (LiPF₆), lithium tetrafluoroborate (LiBF₄), lithium perchlorate (LiClO₄), lithium hexafluoroarsenate (LiAsF₆), lithium tetraphenylborate (LiB(C₆H₅)₄), lithium methanesulfonate (LiCH₃SO₃), lithium trifluoromethanesulfonate (LiCF₃SO₃), lithium tetrachloroaluminate (LiAlCl₄), dilithium hexafluorosilicate (Li₂SiF₆), lithium chloride (LiCl), and lithium bromide (LiBr). In an example embodiment, the lithium salt is any one or more of lithium hexafluorophosphate, lithium tetrafluoroborate, lithium perchlorate, or lithium hexafluoroarsenate. In an example embodiment, the lithium salt is lithium hexafluorophosphate. Although not particularly limited, a content of the electrolyte salt is within a range from 0.3 mol/kg to 3 mol/kg both inclusive with respect to the solvent. In an example embodiment, when the electrolytic solution includes LiPF₆ as the electrolyte salt, a concentration of LiPF₆ in the electrolytic solution is within a range from 1.25 mol/kg to 1.45 mol/kg both inclusive. A reason for this is that this makes it possible to prevent cycle deterioration caused by consumption (decomposition) of the salt at the time of high load rate charging, and thus allows for improvement in high-load cyclability characteristic. In an example embodiment, when the electrolytic solution further includes LiBF4 in addition to LiPF₆ as the electrolyte salt, a concentration of LiBF₄ in the electrolytic solution is within a range from 0.001 (wt %) to 0.1 (wt %) both inclusive. A reason for this is that this makes it possible to more effectively prevent the cycle deterioration caused by consumption (decomposition) of the salt at the time of high load rate charging, and thus allows for further improvement in high-load cyclability characteristic.

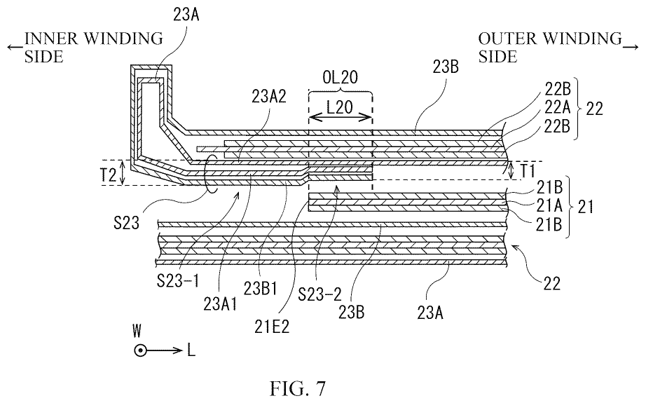

Next, with reference to FIG. 7 in addition to FIG. 3B, a detailed description is given of a positional relationship between the positive electrode 21, the negative electrode 22, and the separator 23 in the vicinity of the center of the electrode wound body 20. FIG. 7 schematically illustrates the vicinity of the center of the electrode wound body 20 illustrated in FIG. 3B.

The separator 23 includes a stacked part S23 in which three or more bases are stacked. Note that in FIG. 3B and FIG. 7, the stacked part S23 has a three-layer structure in which three bases, that is, an inner winding side end part 23A1 of the first separator member 23A, an intermediate part 23A2 of the first separator member 23A, and an inner winding side end part 23B1 of the second separator member 23B, are stacked. Note that the stacked part S23 may include a stack of four or more bases.

In the electrode wound body 20, the inner winding side edge 21E2 of the positive electrode 21, the negative electrode 22, and the stacked part S23 overlap each other in the radial direction of the electrode wound body 20. Note that in FIG. 7, a vertical direction in the sheet plane corresponds to the radial direction of the electrode wound body 20. The first separator member 23A is folded back in a center region of the electrode wound body 20. Note that the center region of the electrode wound body 20 refers to a region that is located on an inner winding side, i.e., a side in a negative direction of the L-axis, relative to an inner winding side end part of the negative electrode current collector 22A in FIG. 7. The center region of the electrode wound body 20 further refers to a region located on the inner winding side relative to the inner winding side end part of the negative electrode current collector 22A in FIG. 3A. Such a structure makes it possible to firmly hold a folded-back part of each of the first and second separator members 23A and 23B on the winding core, thus making it possible to manufacture the electrode wound body accurately in a short time. The inner winding side end part 23A1, of the first separator member 23A, that is folded back is interposed between the inner winding side edge 21E2 of the positive electrode 21 and the negative electrode 22. Similarly, the second separator member 23B is also folded back in the center region of the electrode wound body 20. As with the inner winding side end part 23A1, the inner winding side end part 23B1, of the second separator member 23B, that is folded back is also interposed between the inner winding side edge 21E2 of the positive electrode 21 and the negative electrode 22. Moreover, the intermediate part 23A2, of the first separator member 23A, other than the inner winding side end part 23A1 is also interposed between the inner winding side edge 21E2 of the positive electrode 21 and the negative electrode 22.

In an example embodiment, an overlap part OL20 in which the inner winding side end part 23A1 of the first separator member 23A and the inner winding side end part 23B1 of the second separator member 23B overlap the positive electrode 21 has a length L20 in the L-axis direction that is greater than or equal to 1 mm and shorter than the part of the electrode wound body 20 corresponding to the innermost one wind. Note that the length L20 of the overlap part OL20 is determined in the following manner, for example. First, the electrode wound body 20 is taken out of the outer package can 11. Thereafter, the electrode wound body 20 that is wound is developed, with the positive electrode 21, the first separator member 23A, the negative electrode 22, and the second separator member 23B allowed to remain in the state of being stacked in order. At this time, the electrode wound body 20 is developed on a flat surface, with the positive electrode 21, the first separator member 23A, the negative electrode 22, and the second separator member 23B being fastened together at some locations by means of, for example, clips, to prevent the positional relationship between the positive electrode 21, the first separator member 23A, the negative electrode 22, and the second separator member 23B from becoming out of alignment. Thereafter, the length L20 in the L-axis direction of the overlap part OL20 is measured by means of a ruler.

Further, as illustrated in FIG. 7, the stacked part S23 of the separator 23 includes a first part S23-1 interposed between the positive electrode 21 and the negative electrode 22, and a second part S23-2 not interposed between the positive electrode 21 and the negative electrode 22, and the first part S23-1 has a thickness T1 smaller than a thickness T2 of the second part S23-2, that is, T1<T2. A reason for this is that when the electrode wound body 20 is fabricated by winding the stacked structure S20, the first part S23-1, which is interposed between the innermost wind of the positive electrode 21 including the inner winding side edge 21E2 and the innermost wind of the negative electrode 22, is subjected to a higher pressure than the second part S23-2 located in a region where the positive electrode 21 is absent. Note that in FIG. 7, for the sake of higher recognizability, the positive electrode 21, the negative electrode 22, the first separator member 23A, and the second separator member 23B are illustrated with spacing between every adjacent two of them; however, in actuality, every adjacent two of these components are in close contact with each other.

The thicknesses T1 and T2 of the stacked part S23 of the separator 23 are determined in the following manner, for example. First, the electrode wound body 20 is taken out of the outer package can 11, and the electrode wound body 20 that is wound is developed, with the positive electrode 21, the first separator member 23A, the negative electrode 22, and the second separator member 23B allowed to remain in the state of being stacked in order. Thereafter, the stacked part S23 is cut along the L-axis direction at substantially a midpoint in the W-axis direction. Thereafter, a section resulting from the cutting is cleaned by ion milling to thereby remove unwanted adherents, for example. Thereafter, the cleaned section is observed with a scanning electron microscope to acquire an about 1000-fold magnified image, for example. From the magnified image thus acquired, thicknesses of the stacked part S23 are measured at positions 0.5-mm forward and 0.5-mm backward along the L-axis direction with respect to the inner winding side edge 21E2 as a reference position. For example, a measurement position of the thickness T1 is set to be 0.5 mm away from the position of the inner winding side edge 21E2 toward the outer winding side along the L-axis direction. A measurement position of the thickness T2 is set to be 0.5 mm away from the position of the inner winding side edge 21E2 toward the inner winding side along the L-axis direction.

In the secondary battery 1 according to the present example embodiment, for example, upon charging, lithium ions are extracted from the positive electrode 21, and the extracted lithium ions are inserted into the negative electrode 22 via the electrolytic solution. In the secondary battery 1, for example, upon discharging, lithium ions are extracted from the negative electrode 22, and the extracted lithium ions are inserted into the positive electrode 21 via the electrolytic solution.

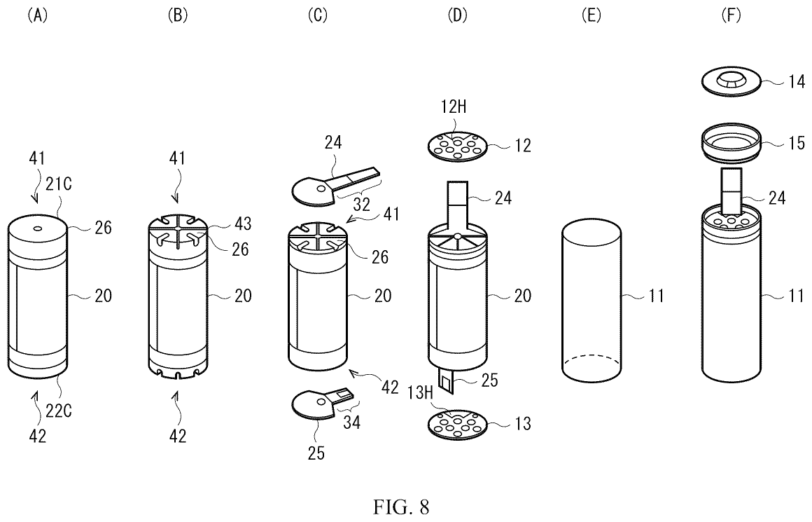

A method of manufacturing the secondary battery 1 will be described with reference to FIG. 8 as well as FIGS. 1 to 5B.

First, the positive electrode current collector 21A is prepared, and the positive electrode active material layer 21B is selectively formed on the surface of the positive electrode current collector 21A to thereby form the positive electrode 21 including the positive electrode covered part 211 and the positive electrode exposed part 212. Thereafter, the negative electrode current collector 22A is prepared, and the negative electrode active material layer 22B is selectively formed on the surface of the negative electrode current collector 22A to thereby form the negative electrode 22 including the negative electrode covered part 221 and the negative electrode exposed part 222. Thereafter, cutouts are formed in respective portions of the positive electrode exposed part 212 and the negative electrode exposed part 222 that correspond to the beginning of winding at the time of performing winding. The positive electrode 21 and the negative electrode 22 may be subjected to a drying process. Thereafter, the stacked structure S20 is fabricated by stacking the positive electrode 21 and the negative electrode 22 with the first separator member 23A and the second separator member 23B interposed therebetween to allow the positive electrode exposed part 212 and the first part 222A of the negative electrode exposed part 222 to be opposite to each other in the W-axis direction. In fabricating the stacked structure S20, the inner winding side end part 23A1 of the first separator member 23A and the inner winding side end part 23B1 of the second separator member 23B are folded back, and these inner winding side end part 23A1 and inner winding side end part 23B1 are caused to be interposed between the inner winding side edge 21E2 of the positive electrode 21 and the negative electrode 22. Thereafter, the stacked structure S20 is so wound in a spiral shape as to form the through hole 26 and allow the cutouts to be positioned in the vicinity of the central axis CL. In addition, the fixing tape 46 is attached to an outermost wind of the stacked structure S20 wound in the spiral shape. The electrode wound body 20 is thus obtained as illustrated in part (A) of FIG. 8.

Thereafter, as illustrated in part (B) of FIG. 8, the end faces 41 and 42 of the electrode wound body 20 are locally bent by pressing an end of, for example, a 0.5-mm-thick flat plate against each of the end faces 41 and 42 perpendicularly, that is, in the Z-axis direction. As a result, grooves 43 are formed to extend radiately in radial directions (R directions) from the through hole 26. Note that the number and arrangement of the grooves 43 illustrated in part (B) of FIG. 8 are merely an example, and an embodiment of the present disclosure is not limited thereto.

Thereafter, as illustrated in part (C) of FIG. 8, substantially equal pressures are applied to the end faces 41 and 42 in substantially perpendicular directions from above and below the electrode wound body 20 at substantially the same time. At this time, for example, a rod-shaped jig is placed in the through hole 26 in advance. By this operation, the positive electrode exposed part 212 and the first part 222A of the negative electrode exposed part 222 are each bent to make the respective end faces 41 and 42 into flat surfaces. At this time, the first edge parts 212E of the positive electrode exposed part 212 located at the end face 41 are caused to bend toward the through hole 26 while overlapping each other, and the second edge parts 222E of the negative electrode exposed part 222 located at the end face 42 are caused to bend toward the through hole 26 while overlapping each other. Thereafter, the fan-shaped part 31 of the positive electrode current collector plate 24 is joined to the end face 41 by, for example, laser welding, and the fan-shaped part 33 of the negative electrode current collector plate 25 is joined to the end face 42 by, for example, laser welding.

Thereafter, the insulating tapes 53 and 54 are attached to predetermined locations on the electrode wound body 20. Thereafter, as illustrated in part (D) of FIG. 8, the band-shaped part 32 of the positive electrode current collector plate 24 is bent and caused to extend through a hole 12H of the insulating plate 12. Further, the band-shaped part 34 of the negative electrode current collector plate 25 is bent and caused to extend through a hole 13H of the insulating plate 13.

Thereafter, the electrode wound body 20 having been assembled in the above-described manner is placed into the outer package can 11 illustrated in part (E) of FIG. 8, following which a bottom part of the outer package can 11 and the negative electrode current collector plate 25 are welded to each other. Thereafter, a narrow part is formed in the vicinity of the open end part 11N of the outer package can 11. Further, the electrolytic solution is injected into the outer package can 11, following which the band-shaped part 32 of the positive electrode current collector plate 24 and the safety valve mechanism 30 are welded to each other.

Thereafter, as illustrated in part (F) of FIG. 8, sealing is performed with the gasket 15, the safety valve mechanism 30, and the battery cover 14, through the use of the narrow part.

The secondary battery 1 according to the present example embodiment is completed in the above-described manner.

As described above, in the secondary battery 1 according to the present example embodiment, the separator 23 includes the stacked part S23 having the three-layer structure in which, as the three bases, the inner winding side end part 23A1 of the first separator member 23A, the intermediate part 23A2 of the first separator member 23A, and the inner winding side end part 23B1 of the second separator member 23B are stacked. The electrode wound body 20 is so wound that the stacked part S23 is interposed between the inner winding side edge 21E2 of the positive electrode 21 and the negative electrode 22. In this way, by allowing the stacked part S23 of the separator 23 to be interposed in a stepped part where the inner winding side edge 21E2 of the positive electrode 21 and the negative electrode 22 overlap each other, it is possible to avoid damage to the separator 23 even when a local stress resulting from the step formed by the inner winding side edge 21E2 of the positive electrode 21 is applied to the separator 23. Accordingly, it is possible to effectively prevent a short circuit between the positive electrode 21 and the negative electrode 22 inside the secondary battery 1.

In the secondary battery 1 according to the present example embodiment, what is called a tabless structure is employed. Accordingly, upon charging and discharging, the electrode wound body 20 easily becomes hot at portions that are located in a wind on the inner winding side near the through hole 26 and coupled to the positive electrode current collector plate 24 and the negative electrode current collector plate 25. Furthermore, at the inner winding side edge 21E2 of the positive electrode 21, a step corresponding to the thickness of the positive electrode 21 develops, which causes the separator 23 located at a position corresponding to the inner winding side edge 21E2 to be subjected to a local stress resulting from expansion and contraction of the electrode wound body 20 associated with charging and discharging. In addition, in a process of manufacturing the secondary battery 1, such as a process of bending the positive electrode exposed part 212 of the positive electrode current collector 21A and the negative electrode exposed part 222 of the negative electrode current collector 22A, the presence of the above-described step also becomes a cause of a local stress being applied to the separator 23 located at the position corresponding to the inner winding side edge 21E2. Accordingly, in order to prevent an internal short circuit, it is demanded that the separator 23 have sufficient strength in a part located at the position corresponding to the inner winding side edge 21E2. To meet the demand, in the present example embodiment, the stacked part S23 in which the three bases are stacked is disposed at the position corresponding to the inner winding side edge 21E2 to thereby ensure sufficient strength of the separator 23.

Further, in the secondary battery 1 according to the present example embodiment, as illustrated in FIG. 3B, the stacked part S23 of the separator 23 is provided between the innermost wind of the positive electrode including the inner winding side edge 21E2 of the positive electrode 21 and the innermost wind of the negative electrode located on the inner side relative to the innermost wind of the positive electrode. That is, the stacked part S23 is provided at a location that is more susceptible to a high local stress than other locations. This makes it possible to further improve safety.

Further, in the secondary battery 1 according to the present example embodiment, the length L20 of the overlap part OL20 in the L-axis direction is set to be greater than or equal to 1mm and shorter than the part of the electrode wound body 20 corresponding to the innermost one wind. By allowing the stacked part S23 of the separator 23 to overlap the positive electrode 21 over a length of 1 mm or greater, it is possible to sufficiently prevent the occurrence of a short circuit even when a local stress resulting from the step of the inner winding side edge 21E2 of the positive electrode 21 is applied to the separator 23. Further, making the length L20 of the overlap part OL20 shorter than the part of the electrode wound body 20 corresponding to the innermost one wind allows for space savings inside the outer package can 11, which makes it possible to avoid a reduction in battery capacity.

Further, in the secondary battery 1 according to the present example embodiment, as illustrated in FIG. 4A, the positive electrode current collector 21A is covered with the positive electrode active material layer 21B from the outer winding side edge 21E1 to the inner winding side edge 21E2 of the positive electrode 21 in the electrode wound body 20. Accordingly, as compared with a case in which, for example, a region where the positive electrode current collector 21 A is exposed is present in the vicinity of the inner winding side edge 21E1 in the L-axis direction, it is possible to eliminate portions of the positive electrode current collector 21A and the negative electrode active material layer 22B opposed to each other, and to thereby ensure high safety. Moreover, it is possible to increase an area for formation of the negative electrode active material layer 22B, which makes it possible to increase the battery capacity. Note that providing the positive electrode active material layer 21B to reach the outer winding side edge 21E1 results in a large step at the outer winding side edge 21E1. However, the secondary battery 1 according to the present example embodiment makes it possible to prevent the occurrence of a short circuit because the strength of the separator 23 is enhanced by the interposition of the stacked part S23 of the separator 23 as described above.

Further, in the secondary battery 1 according to the present example embodiment, the positive electrode 21 may be provided with the insulating layer 101, and the insulating layer 101 may be adhered to the first separator member 23A, the second separator member 23B, or both. This makes it possible to prevent the positive electrode 21 and the separator 23 from becoming misaligned with each other. As a result, the stacked part S23 is prevented from easily shifting out of a predetermined position, that is, the position corresponding to the stepped part where the inner winding side edge 21E2 and the negative electrode 22 overlap each other. This makes it possible to more effectively prevent the occurrence of a short circuit. Moreover, the insulating layer 101 may include a resin including PVDF. A reason for this is that in such a case, the insulating layer 101 is swollen by, for example, the solvent included in the electrolytic solution, which makes it possible for the insulating layer 101 to be favorably adhered to the separator 23.

Non-limiting examples of applications of the lithium-ion secondary battery 1 according to an embodiment of the present disclosure are as described below in further detail.

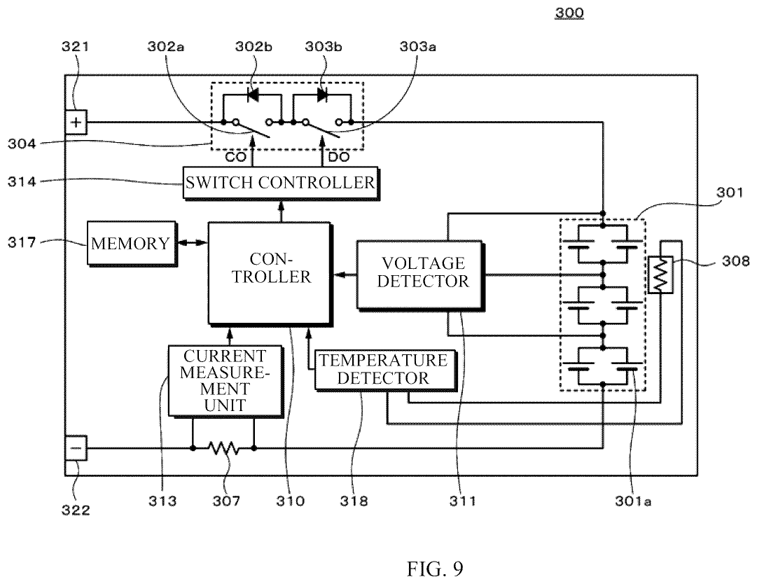

FIG. 9 is a block diagram illustrating a circuit configuration example in which a battery according to an example embodiment of the present disclosure, which will hereinafter be referred to as a secondary battery as appropriate, is applied to a battery pack 300. The battery pack 300 includes an assembled battery 301, an outer package, a switch unit 304, a current detection resistor 307, a temperature detection device 308, and a controller 310. The switch unit 304 includes a charge control switch 302a and a discharge control switch 303a.

The battery pack 300 includes a positive electrode terminal 321 and a negative electrode terminal 322. Upon charging, the positive electrode terminal 321 and the negative electrode terminal 322 are respectively coupled to a positive electrode terminal and a negative electrode terminal of a charger to perform charging. Upon use of electronic equipment, the positive electrode terminal 321 and the negative electrode terminal 322 are respectively coupled to a positive electrode terminal and a negative electrode terminal of the electronic equipment to perform discharging.

The assembled battery 301 includes multiple secondary batteries 301a coupled in series or in parallel. The secondary battery 1 described above is applicable to each of the secondary batteries 301a. FIG. 9 illustrates an example case in which six secondary batteries 301a are coupled in a two parallel coupling and three series coupling (2P3S) configuration; however, the secondary batteries 301a may be coupled in any other manner such as in any n parallel coupling and m series coupling configuration, where n and m are integers.

The switch unit 304 includes the charge control switch 302a, a diode 302b, the discharge control switch 303a, and a diode 303b, and is controlled by the controller 310. The diode 302b has a polarity that is in a reverse direction with respect to a charge current flowing in a direction from the positive electrode terminal 321 to the assembled battery 301, and in a forward direction with respect to a discharge current flowing in a direction from the negative electrode terminal 322 to the assembled battery 301. The diode 303b has a polarity that is in the forward direction with respect to the charge current and in the reverse direction with respect to the discharge current. In FIG. 9, the switch unit 304 is provided on a positive side; however, the switch unit 304 may be provided on a negative side.

The charge control switch 302a is so controlled by a charge and discharge controller that when the battery voltage reaches an overcharge detection voltage, the charge control switch 302a is turned off to thereby prevent the charge current from flowing through a current path of the assembled battery 301. After the charge control switch 302a is turned off, only discharging is enabled through the diode 302b. Further, the charge control switch 302a is so controlled by the controller 310 that when a large current flows upon charging, the charge control switch 302a is turned off to thereby block the charge current flowing through the current path of the assembled battery 301. The discharge control switch 303a is so controlled by the controller 310 that when the battery voltage reaches an overdischarge detection voltage, the discharge control switch 303a is turned off to thereby prevent the discharge current from flowing through the current path of the assembled battery 301. After the discharge control switch 303a is turned off, only charging is enabled through the diode 303b. Further, the discharge control switch 303a is so controlled by the controller 310 that when a large current flows upon discharging, the discharge control switch 303a is turned off to thereby block the discharge current flowing through the current path of the assembled battery 301.

The temperature detection device 308 is, for example, a thermistor. The temperature detection device 308 is provided in the vicinity of the assembled battery 301, measures a temperature of the assembled battery 301, and supplies the measured temperature to the controller 310. A voltage detector 311 measures a voltage of the assembled battery 301 and a voltage of each of the secondary batteries 301a included therein, performs A/D conversion on the measured voltages, and supplies the converted voltages to the controller 310. A current measurement unit 313 measures a current by means of the current detection resistor 307, and supplies the measured current to the controller 310. A switch controller 314 controls the charge control switch 302a and the discharge control switch 303a of the switch unit 304, based on the voltages supplied from the voltage detector 311 and the current supplied from the current measurement unit 313.

When any of the secondary batteries 301a reaches the overcharge detection voltage or below, or reaches the overdischarge detection voltage or below, or when a large current flows suddenly, the switch controller 314 transmits a control signal to the switch unit 304 to thereby prevent overcharging and overdischarging, and overcurrent charging and discharging. For example, when the secondary battery is a lithium-ion secondary battery, the overcharge detection voltage is determined to be, for example, 4.20 V±0.05 V, and the overdischarge detection voltage is determined to be, for example, 2.4 V±0.1 V.

As the charge and discharge control switches, for example, semiconductor switches such as MOSFETs are usable. In this case, parasitic diodes of the MOSFETs serve as the diodes 302b and 303b. When P-channel FETs are used as the charge and discharge control switches, the switch controller 314 supplies control signals DO and CO to respective gates of the charge control switch 302a and the discharge control switch 303a. When the charge control switch 302a and the discharge control switch 303a are of P-channel type, the charge control switch 302a and the discharge control switch 303a are turned on by a gate potential that is lower than a source potential by a predetermined value or more. For example, in normal charging and discharging operations, the control signals CO and DO are set to a low level to turn on the charge control switch 302a and the discharge control switch 303a.

For example, upon overcharging or overdischarging, the control signals CO and DO are set to a high level to turn off the charge control switch 302a and the discharge control switch 303a.

A memory 317 includes a RAM and a ROM. For example, the memory 317 includes an EPROM (erasable programmable read only memory) that is a nonvolatile memory. In the memory 317, values including, without limitation, numerical values calculated by the controller 310 and a battery's internal resistance value of each of the secondary batteries 301a in an initial state measured in the manufacturing process stage, are stored in advance and are rewritable on an as-needed basis. Further, by storing a full charge capacity of the secondary battery 301a, it is possible to calculate, for example, a remaining capacity with the controller 310.

A temperature detector 318 measures a temperature with use of the temperature detection device 308, performs charge and discharge control upon abnormal heat generation, and performs correction in calculating the remaining capacity.

The secondary battery according to the foregoing example embodiment of the present disclosure is mountable on, or usable to supply electric power to, for example, any of equipment including, without limitation, electronic equipment, an electric vehicle, an electric aircraft, and a power storage apparatus.

Non-limiting examples of the electronic equipment include laptop personal computers, smartphones, tablet terminals, PDAs (mobile information terminals), mobile phones, wearable terminals, cordless phone handsets, hand-held video recording and playback devices, digital still cameras, electronic books, electronic dictionaries, music players, radios, headphones, game machines, navigation systems, memory cards, pacemakers, hearing aids, electric tools, electric shavers, refrigerators, air conditioners, televisions, stereos, water heaters, microwave ovens, dishwashers, washing machines, dryers, lighting equipment, toys, medical equipment, robots, road conditioners, and traffic lights.

Non-limiting examples of the electric vehicle include railway vehicles, golf carts, electric carts, and electric automobiles including hybrid electric automobiles. The secondary battery is usable as a driving power source or an auxiliary power source for any of these electric vehicles. Non-limiting examples of the power storage apparatuses include a power storage power source for architectural structures including residential houses, or for power generation facilities.

A description is given below of examples of a power storage system that includes, among the above-described applications, the power storage apparatus to which the secondary battery 1 of an embodiment of the present disclosure described above is applied.

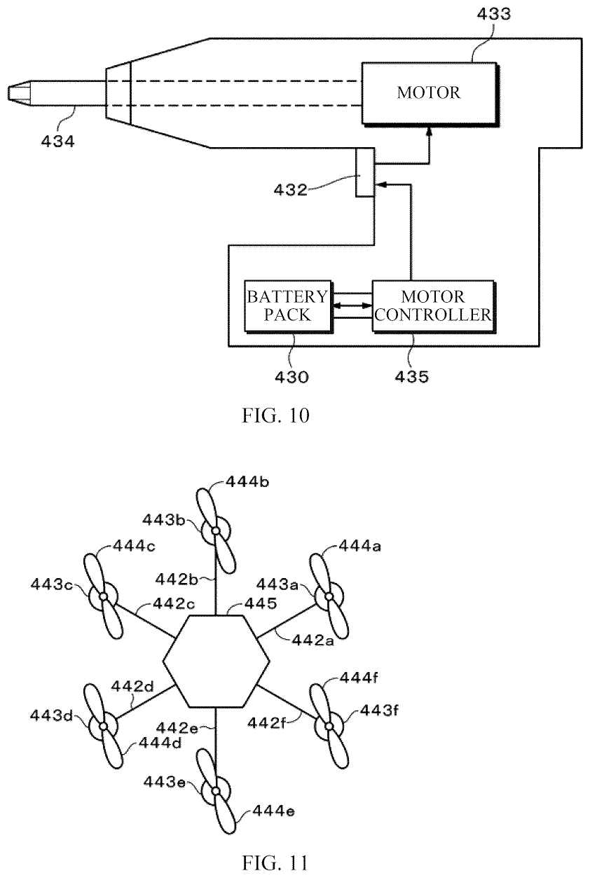

An example of an electric screwdriver as an electric tool to which the secondary battery of an embodiment of the present disclosure is applicable will be schematically described with reference to FIG. 10. An electric screwdriver 431 has a body in which a motor 433 such as a DC motor is contained. Rotation of the motor 433 is transmitted to a shaft 434, and the shaft 434 drives a screw into a target object. The electric screwdriver 431 is provided with a trigger switch 432 to be operated by a user.

A battery pack 430 and a motor controller 435 are contained in a lower housing of a handle of the electric screwdriver 431. The battery pack 300 is usable as the battery pack 430. The motor controller 435 controls the motor 433. Components of the electric screwdriver 431 other than the motor 433 may each be controlled by the motor controller 435. The battery pack 430 and the electric screwdriver 431 are engaged with each other by respective engaging members provided therein. As will be described later, the battery pack 430 and the motor controller 435 include respective microcomputers. Battery power is supplied from the battery pack 430 to the motor controller 435, and the respective microcomputers of the battery pack 430 and the motor controller 435 communicate with each other to transmit and receive data on the battery pack 430.

The battery pack 430 is, for example, detachably attached to the electric screwdriver 431. The battery pack 430 may be built in the electric screwdriver 431. The battery pack 430 is mounted on a charging device when charging is performed. When the battery pack 430 is mounted on the electric screwdriver 431, a portion of the battery pack 430 may be exposed to the outside of the electric screwdriver 431 to allow the exposed portion to be visible to the user. For example, the exposed portion of the battery pack 430 may be provided with an LED to make it possible for the user to check light emission and extinction of the LED.

The motor controller 435 controls, for example, rotation and stopping of the motor 433 and a rotation direction of the motor 433. Furthermore, the motor controller 435 blocks power supply to a load upon overdischarging. For example, the trigger switch 432 is interposed between the motor 433 and the motor controller 435. Upon pressing of the trigger switch 432 by the user, power is supplied to the motor 433 to cause the motor 433 to rotate. Upon returning of the trigger switch 432 by the user, the rotation of the motor 433 stops.

An example in which the secondary battery of an embodiment of the present disclosure is applied to a power source for an electric aircraft will be described with reference to FIG. 11. The secondary battery of an embodiment of the present disclosure is applicable as a power source for an unmanned aircraft such as a drone. FIG. 11 is a plan view of the unmanned aircraft. The unmanned aircraft has an airframe including a fuselage part of a circular cylindrical or rectangular cylindrical shape as a center part, and support shafts 442a to 442f fixed to an upper part of the fuselage part. In FIG. 11, the fuselage part has a hexagonal cylindrical shape with six support shafts 442a to 442f extending radially from a center of the fuselage part at equal angular intervals. The fuselage part and the support shafts 442a to 442f each include a lightweight and high-strength material.

Motors 443a to 443f as drive sources for rotary wings are attached to respective tip parts of the support shafts 442a to 442f. Rotary wings 444a to 444f are attached to respective rotary shafts of the motors 443a to 443f. A circuit unit 445 including a motor control circuit for controlling each motor is attached to the center part, i.e., the upper part of the fuselage part where the support shafts 442a to 442f intersect.

Further, a battery unit as a power source is disposed at a position below the fuselage part. The battery unit includes three battery packs to supply electric power to pairs of motors and rotary wings that have an opposing interval of 180 degrees. Each battery pack includes, for example, a lithium-ion secondary battery and a battery control circuit that controls charging and discharging. The battery pack 300 is usable as the battery pack. A combination of the motor 443a and the rotary wing 444a and a combination of the motor 443d and the rotary wing 444d pair up with each other. Similarly, a combination of the motor 443b and the rotary wing 444b and a combination of the motor 443e and the rotary wing 444e pair up with each other; and a combination of the motor 443c and the rotary wing 444c and a combination of the motor 443f and the rotary wing 444f pair up with each other. The number of these pairs and the number of the battery packs are equal.

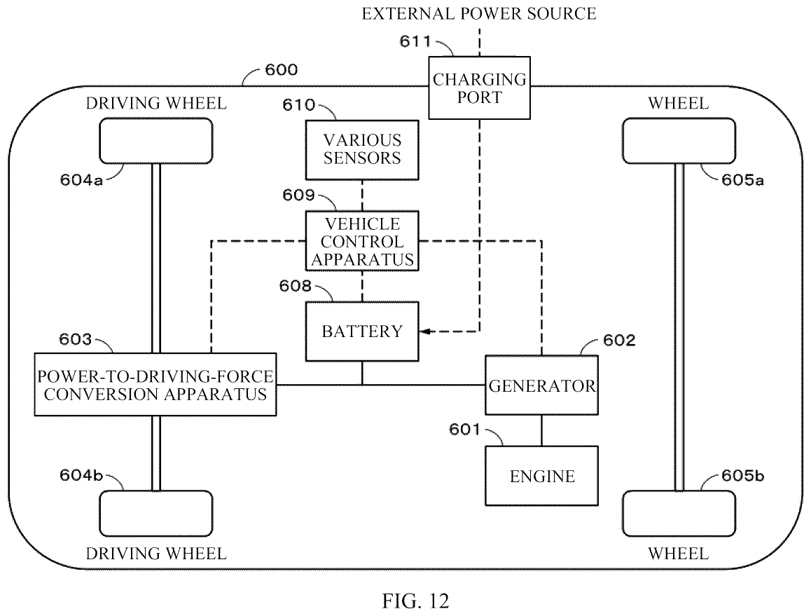

An example in which the secondary battery of an embodiment of the present disclosure is applied to a power storage system for an electric vehicle will be described with reference to FIG. 12. FIG. 12 schematically illustrates an example of a configuration of a hybrid vehicle that employs a series hybrid system to which the secondary battery of an embodiment of the present disclosure is applicable. The series hybrid system relates to a vehicle that travels with a power-to-driving-force conversion apparatus, using electric power generated by a generator driven by an engine or using electric power temporarily stored in a battery.

A hybrid vehicle 600 is equipped with an engine 601, a generator 602, a power-to-driving-force conversion apparatus 603, a driving wheel 604a, a driving wheel 604b, a wheel 605a, a wheel 605b, a battery 608, a vehicle control apparatus 609, various sensors 610, and a charging port 611. The battery pack 300 of an embodiment of the present disclosure described above is applicable to the battery 608.

The hybrid vehicle 600 travels with the power-to-driving-force conversion apparatus 603 as a power source. An example of the power-to-driving-force conversion apparatus 603 is a motor. The power-to-driving-force conversion apparatus 603 operates under electric power of the battery 608, and a rotational force of the power-to-driving-force conversion apparatus 603 is transmitted to the driving wheels 604a and 604b. Note that both an alternating-current motor and a direct-current motor are applicable as the power-to-driving-force conversion apparatus 603 by using direct-current-to-alternating-current (DC-AC) conversion or reverse conversion (AC-DC conversion) at a location where such conversion is necessary. The various sensors 610 control an engine speed via the vehicle control apparatus 609, and control an opening angle, i.e., a throttle position, of an unillustrated throttle valve. The various sensors 610 include a speed sensor, an acceleration sensor, and an engine speed sensor.

A rotational force of the engine 601 is transmitted to the generator 602, and electric power generated by the generator 602 from the rotational force is storable in the battery 608. When the hybrid vehicle 600 is decelerated by an unillustrated brake mechanism, a resistance force at the time of deceleration is applied to the power-to-driving-force conversion apparatus 603 as a rotational force, and regenerative electric power generated by the power-to-driving-force conversion apparatus 603 from the rotational force is stored in the battery 608.

By coupling the battery 608 to a power source outside the hybrid vehicle 600, it is possible for the battery 608 to be supplied with electric power from the outside power source via the charging port 611 as an input port, and to store the supplied electric power.

Further, the hybrid vehicle 600 may include a data processing apparatus that performs data processing related to vehicle control, based on data related to the secondary battery. Non-limiting examples of such a data processing apparatus include a data processing apparatus that indicates a remaining battery level, based on data related to the remaining level of the battery. The description above has dealt with, as an example, a series hybrid vehicle that travels by means of the motor using electric power generated by the generator driven by the engine, or using electric power temporarily stored in the battery. However, the secondary battery of an embodiment of the present disclosure is also effectively applicable to a parallel hybrid vehicle which uses outputs of both an engine and a motor as driving sources and appropriately switches between three traveling modes, i.e., traveling only by means of the engine, traveling only by means of the motor, and traveling by means of the engine and the motor. Furthermore, the secondary battery of an embodiment of the present disclosure is also effectively applicable to what is called an electric vehicle that travels by being driven by only a driving motor without the use of an engine.

### EXAMPLES

Examples of the present disclosure will be described in further detail according to an embodiment.

### 1. Presence or Absence of Internal Short Circuit

### Example 1-1

As described below, the lithium-ion secondary battery 1 of the cylindrical type illustrated in, for example, FIG. 1 was fabricated, and was thereafter evaluated for a battery characteristic. Here, the lithium-ion secondary battery was fabricated with dimensions of 21 mm in diameter and 70 mm in length.

### Fabrication Method

First, an aluminum foil having a thickness of 12 μm was prepared as the positive electrode current collector 21A. Thereafter, a layered lithium oxide, as the positive electrode active material, that included lithium nickel cobalt aluminum oxide (NCA) having a Ni ratio of 85% or more, was mixed with a positive electrode binder including polyvinylidene difluoride and a conductive additive including a mixture of carbon black, acetylene black, and Ketjen black to thereby obtain a positive electrode mixture. A mixture ratio between the positive electrode active material, the positive electrode binder, and the conductive additive was set to 96.4:2:1.6. Thereafter, the positive electrode mixture was put into an organic solvent (N-methyl-2-pyrrolidone), following which the organic solvent was stirred to thereby prepare a positive electrode mixture slurry in paste form. Thereafter, the positive electrode mixture slurry was applied on respective predetermined regions of both surfaces of the positive electrode current collector 21A by means of a coating apparatus, following which the applied positive electrode mixture slurry was dried to thereby form the positive electrode active material layers 21B. Further, a coating material including polyvinylidene difluoride (PVDF) was applied on surfaces of the positive electrode exposed part 212, at respective regions adjacent to the positive electrode covered part 211. The applied coating material was dried to thereby form the insulating layers 101 each having a width of 3 mm and a thickness of 8 μm. Thereafter, the positive electrode active material layers 21B were compression-molded by means of a roll pressing machine. Thus, the positive electrode 21 including the positive electrode covered part 211 and the positive electrode exposed part 212 was obtained. Here, a width of the positive electrode covered part 211 in the W-axis direction was set to 60 mm, and a width of the positive electrode exposed part 212 in the W-axis direction was set to 7 mm. Further, a length of the positive electrode 21 in the L-axis direction was set to 1700 mm. In the positive electrode 21 thus obtained, the positive electrode active material layer 21B had an area density of 22.0 mg/cm² and a volume density of 3.55 g/cm³. The thickness t2 of the positive electrode covered part 211 was 74.3 μm.

Further, a copper foil having a thickness of 8 μm was prepared as the negative electrode current collector 22A. Thereafter, the negative electrode active material including a mixture of a carbon material (including graphite) and SiO was mixed with a negative electrode binder including polyvinylidene difluoride and a conductive additive including a mixture of carbon black, acetylene black, and Ketjen black to thereby obtain a negative electrode mixture. A mixture ratio between the negative electrode active material, the negative electrode binder, and the conductive additive was set to 96.1:2.9:1.0. A mixture ratio between graphite and SiO in the negative electrode active material was set to 95:5. Thereafter, the negative electrode mixture was put into an organic solvent (N-methyl-2-pyrrolidone), following which the organic solvent was stirred to thereby prepare a negative electrode mixture slurry in paste form. Thereafter, the negative electrode mixture slurry was applied on respective predetermined regions of both surfaces of the negative electrode current collector 22A by means of a coating apparatus, following which the applied negative electrode mixture slurry was dried to thereby form the negative electrode active material layers 22B. Thereafter, the negative electrode active material layers 22B were compression-molded by means of a roll pressing machine. Thus, the negative electrode 22 including the negative electrode covered part 221 and the negative electrode exposed part 222 was obtained. Here, a width of the negative electrode covered part 221 in the W-axis direction was set to 62 mm, and a width of the first part 222A of the negative electrode exposed part 222 in the W-axis direction was set to 4 mm. Further, a length of the negative electrode 22 in the L-axis direction was set to 1760 mm. In the negative electrode 22 thus obtained, the negative electrode active material layer 22B had an area density of 10.83 mg/cm² and a volume density of 1.50 g/cm³. The negative electrode covered part 221 had a thickness of 80.2 μm.

Thereafter, the stacked structure S20 was fabricated by stacking the positive electrode 21 and the negative electrode 22 with the first separator member 23A and the second separator member 23B interposed therebetween to allow the positive electrode exposed part 212 and the first part 222A of the negative electrode exposed part 222 to be opposite to each other in the W-axis direction. At this time, the stacked structure S20 was fabricated not to allow the positive electrode active material layers 21B to protrude from the negative electrode active material layers 22B in the W-axis direction. As each of the first separator member 23A and the second separator member 23B, used was a polyethylene sheet having a width of 65 mm and a thickness of 14 μm. In fabricating the stacked structure S20, the inner winding side end part 23A1 of the first separator member 23A and the inner winding side end part 23B1 of the second separator member 23B were folded back, and these inner winding side end part 23A1 and inner winding side end part 23B1 were caused to be interposed between the inner winding side edge 21E2 of the positive electrode 21 and the negative electrode 22. Here, the length L20 of the overlap part OL20 was adjusted to 1 mm. Thereafter, the stacked structure S20 was so wound in a spiral shape as to form the through hole 26 and allow the cutouts to be positioned in the vicinity of the central axis CL, and the fixing tape 46 was attached to the outermost wind of the stacked structure S20 thus wound. The electrode wound body 20 was thereby obtained.

Thereafter, the end faces 41 and 42 of the electrode wound body 20 were locally bent by pressing an end of a 0.5-mm-thick flat plate against each of the end faces 41 and 42 in the Z-axis direction. The grooves 43 extending radiately in the radial directions (the R directions) from the through hole 26 were thereby formed.

Thereafter, substantially equal pressures were applied to the end faces 41 and 42 substantially perpendicularly from above and below the electrode wound body 20 at substantially the same time. The positive electrode exposed part 212 and the first part 222A of the negative electrode exposed part 222 were thereby bent to make the end faces 41 and 42 into flat surfaces. At this time, the first edge parts 212E of the positive electrode exposed part 212 located at the end face 41 were caused to bend toward the through hole 26 while overlapping each other, and the second edge parts 222E of the negative electrode exposed part 222 located at the end face 42 were caused to bend toward the through hole 26 while overlapping each other. Thereafter, the fan-shaped part 31 of the positive electrode current collector plate 24 was joined to the end face 41 by laser welding, and the fan-shaped part 33 of the negative electrode current collector plate 25 was joined to the end face 42 by laser welding.

Thereafter, the insulating tapes 53 and 54 were attached to the predetermined locations on the electrode wound body 20, following which the band-shaped part 32 of the positive electrode current collector plate 24 was bent and caused to extend through the hole 12H of the insulating plate 12, and the band-shaped part 34 of the negative electrode current collector plate 25 was bent and caused to extend through the hole 13H of the insulating plate 13.

Thereafter, the electrode wound body 20 having been assembled in the above-described manner was placed into the outer package can 11, following which the bottom part of the outer package can 11 and the negative electrode current collector plate 25 were welded to each other. Thereafter, the narrow part was formed in the vicinity of the open end part 11N of the outer package can 11. Further, the electrolytic solution was injected into the outer package can 11, following which the band-shaped part 32 of the positive electrode current collector plate 24 and the safety valve mechanism 30 were welded to each other.

As the electrolytic solution, used was a solution including a solvent prepared by adding fluoroethylene carbonate (FEC) and succinonitrile (SN) to ethylene carbonate (EC) and dimethyl carbonate (DMC) as a main solvent, and including LiBF₄ and LiPF₆ as the electrolyte salt. In the lithium-ion secondary battery of the present Example, a content ratio (wt %) between EC, DMC, FEC, SN, LiBF₄, and LiPF₆ in the electrolytic solution was set to 12.7:56.2:12.0:1.0:1.0:17.1.

Lastly, sealing was performed with the gasket 15, the safety valve mechanism 30, and the battery cover 14, through the use of the narrow part.

The lithium-ion secondary battery 1 of Example 1-1 was thus obtained. The number of samples was set to 12.

### Evaluation of Battery Characteristic

Evaluation of the battery characteristic of the lithium-ion secondary battery 1 of Example 1-1 obtained as described above revealed the results presented in Table 1. More specifically, a cycle test was performed under the following test conditions, following which whether a short circuit occurred inside the lithium-ion secondary battery 1 was investigated. Whether a short circuit occurred was determined as follows. An open circuit voltage (OCV) after the cycle test was measured over 48 hours, and if a voltage drop of 150 mV or more from an initial voltage was observed, it was determined that a short circuit occurred. The test conditions for the cycle test were as follows.

### Cycle Test Conditions

(1) Ambient temperature at which the test was performed: 23° C.
(2) Charge conditions: Constant current and constant voltage (CC-CV) charging was performed. Charging was performed with a constant current of 6 A to a voltage of 4.2 V, following which charging was performed with a constant voltage of 4.2 V. A cutoff current was set to 1 A.
(3) Rest time after charging: 30 minutes.
(4) Discharge conditions: Constant current (CC) discharging was performed with a constant current of 50 A. A cutoff voltage was set to 2.5 V, or discharging was stopped when a temperature reached 85° C.
(5) Rest after discharging: A rest was taken until a battery surface temperature fell below 30° C.
(6) Number of cycles: 100 cycles.

TABLE 1

| | Number of layers | Number of samples |
|---|---|---|
| | of separator in | in which short |
| | overlap part | circuits occurred |
| Example 1-1 | 3 | 0/12 |
| Comparative | 1 | 4/12 |
| example 1-1 | | |
| Comparative | 2 | 2/12 |
| example 1-2 | | |

### Comparative Example 1-1

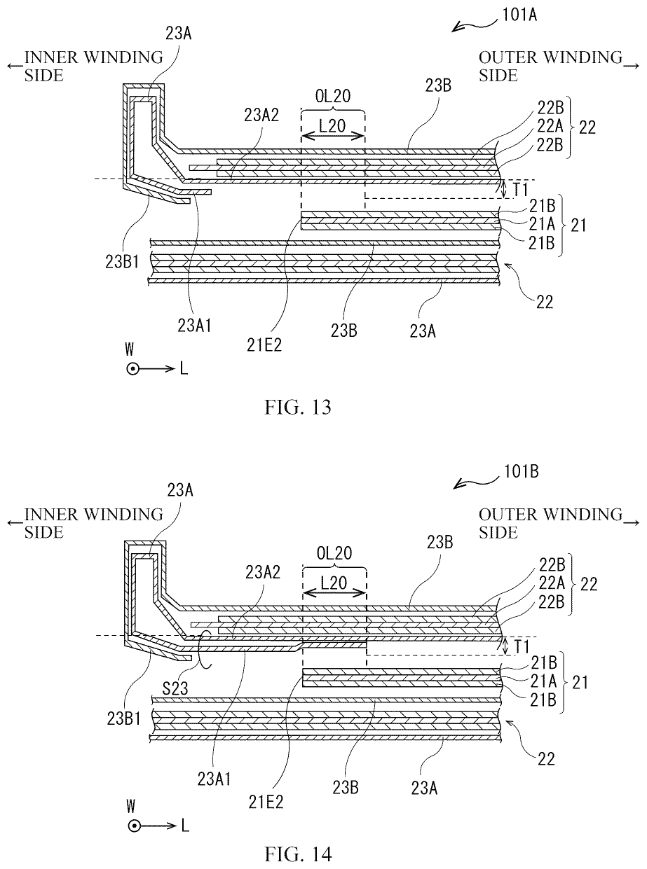

A lithium-ion secondary battery 101A was fabricated as Comparative example 1-1 (the number n of samples: 12). In the lithium-ion secondary battery 101A of Comparative example 1-1, when fabricating the stacked structure S20, as illustrated in FIG. 13, neither the inner winding side end part 23A1, of the first separator member 23A, that was folded back nor the inner winding side end part 23B1, of the second separator member 23B, that was folded back was allowed to reach the inner winding side edge 21E2 of the positive electrode 21. In other words, neither the inner winding side end part 23A1 nor the inner winding side end part 23B1 was allowed to be present between the inner winding side edge 21E2 of the positive electrode 21 and the negative electrode 22. The lithium-ion secondary battery 101A of Comparative example 1-1 was otherwise the same in configuration as the lithium-ion secondary battery 1 of Example 1-1. Battery characteristic evaluation similar to that performed on the lithium-ion secondary battery 1 was also performed on the lithium-ion secondary battery 101A. The results are presented in Table 1.

### Comparative Example 1-2

A lithium-ion secondary battery 101B was fabricated as Comparative example 1-2 (the number n of samples: 12). In the lithium-ion secondary battery 101B of Comparative example 1-2, when fabricating the stacked structure S20, as illustrated in FIG. 14, of the inner winding side end part 23A1 of the first separator member 23A and the inner winding side end part 23B1 of the second separator member 23B that were folded back, only the inner winding side end part 23A1 was allowed to be present between the inner winding side edge 21E2 of the positive electrode 21 and the negative electrode 22. In other words, in the lithium-ion secondary battery 101B of Comparative example 1-2, the stacked part S23 was configured by two bases. The lithium-ion secondary battery 101B was otherwise the same in configuration as the lithium-ion secondary battery 1 of Example 1-1. Battery characteristic evaluation similar to that performed on the lithium-ion secondary battery 1 was also performed on the lithium-ion secondary battery 101B. The results are presented in Table 1.

As indicated in Table 1, for Example 1-1, no internal short circuit occurred in any of the samples. In contrast, for Comparative example 1-1, internal short circuits occurred in four of the twelve samples; and for Comparative example 1-2, internal short circuits occurred in two of the twelve samples. Accordingly, it was confirmed that effective prevention of the internal short circuit was possible when the separator included the stacked part in which three or more bases were stacked, and the stacked part, the inner winding side edge of the positive electrode, and the negative electrode were allowed to overlap each other.

### 2. Comparison of Discharge Capacity

### Example 2-1

### Fabrication Method

The lithium-ion secondary battery 1 was fabricated as Example 2-1 (the number n of samples: 12). In the lithium-ion secondary battery 1 of Example 2-1, when fabricating the stacked structure S20, the length L20 of the overlap part OL20 was adjusted to 15 mm. The length L20 of 15 mm was slightly shorter than the length of the part of the electrode wound body 20 corresponding to the innermost one wind. The lithium-ion secondary battery 1 of Example 2-1 was otherwise the same in configuration as the lithium-ion secondary battery 1 of Example 1-1.

### Evaluation of Battery Characteristic

Evaluation of the battery characteristic of the secondary battery 1 of Example 2-1 (the number n of samples: 12) obtained as described above revealed the results presented in Table 2. More specifically, a discharge test was performed under the following test conditions to thereby measure a discharge capacity [mAh]. The test conditions for the discharge test were as follows.

### Discharge Test Conditions

(1) Ambient temperature at which the test was performed: 23° C.
(2) Charge conditions: Constant current and constant voltage (CC-CV) charging was performed. Charging was performed with a constant current of 2.5 A to a voltage of 4.2 V, following which charging was performed with a constant voltage of 4.2 V. The cutoff current was set to 0.05 A.
(3) Rest time after charging: 30 minutes.
(4) Discharge conditions: Constant current (CC) discharging was performed with a constant current of 0.5 A. The cutoff voltage was set to 2.5 V.

TABLE 2

| | Length L20 | Discharge |
|---|---|---|
| | [mm] of | capacity |
| | overlap part | [mAh] |
| Example 2-1 | 15 | 2562 |
| Comparative | — | 2567 |
| example 2-1 | | |

### Comparative Example 2-1

The lithium-ion secondary battery 101A illustrated in FIG. 13 was fabricated as Comparative example 2-1 (the number n of samples: 12). The lithium-ion secondary battery 101A of Comparative example 2-1 was the same as the lithium-ion secondary battery 101A of Comparative example 1-1. Battery characteristic evaluation similar to that performed on the lithium-ion secondary battery 1 of Example 2-1 was also performed on the lithium-ion secondary battery 101A of Comparative example 2-1. The results are presented in Table 2.

As indicated in Table 2, almost equal discharge capacities were obtained in Example 2-1 and Comparative example 2-1. Accordingly, in an embodiment of the present disclosure, it was confirmed that when the length L20 of the overlap part OL20 was shorter than the length of the part of the electrode wound body 20 corresponding to the innermost one wind, it was possible to avoid a reduction in discharge capacity.

Although the present technology has been described herein including with reference to an embodiment including Examples, the configuration of an embodiment of the present technology is not limited to the configuration described in relation to the example embodiments and Examples, and is therefore modifiable in a variety of ways.

For example, although the description has been given of the case where the electrode reactant is lithium, the electrode reactant is not particularly limited. Accordingly, the electrode reactant may be another alkali metal such as sodium or potassium, or may be an alkaline earth metal such as beryllium, magnesium, or calcium, as described above. In addition, the electrode reactant may be another light metal such as aluminum.

The effects described herein are mere examples, and effects of an embodiment of the present technology are therefore not limited to those described herein. Accordingly, an embodiment of the present technology may achieve any other effect.

Furthermore, the present disclosure encompasses any possible combination of some or all of the various embodiments and the modification examples described herein and incorporated herein.

It is possible to achieve at least the following configurations from the foregoing example embodiments and modification examples of the present disclosure.
(1)

A secondary battery including:
an electrode wound body including a stacked structure wound around a central axis extending in a first direction, the stacked structure including a positive electrode and a negative electrode that are stacked with a separator interposed therebetween;
a positive electrode current collector plate facing a first end face of the electrode wound body, the first end face being in the first direction;
a negative electrode current collector plate facing a second end face of the electrode wound body, the second end face being opposite to the first end face in the first direction; and
an electrolytic solution; and
a battery can containing the electrode wound body, the positive electrode current collector plate, the negative electrode current collector plate, and the electrolytic solution, in which
the positive electrode includes a positive electrode covered part in which a positive electrode current collector is covered with a positive electrode active material layer, and a positive electrode exposed part in which the positive electrode current collector is not covered with the positive electrode active material layer and is exposed, the positive electrode exposed part being joined to the positive electrode current collector plate,
the negative electrode includes a negative electrode covered part in which a negative electrode current collector is covered with a negative electrode active material layer, and a negative electrode exposed part in which the negative electrode current collector is not covered with the negative electrode active material layer and is exposed, the negative electrode exposed part being joined to the negative electrode current collector plate,
the separator includes a stacked part in which three or more bases are stacked, at least two of the three or more bases being folded back in a center region of the electrode wound body, the center region of the electrode wound body being a region located on an inner winding side relative to an inner winding side end part of the negative electrode current collector, and
in the electrode wound body, an inner winding side edge of the positive electrode, the negative electrode, and the stacked part overlap each other.
(2)

The secondary battery according to (1), in which the stacked part of the separator is provided between an innermost positive electrode wind part of the positive electrode and an innermost negative electrode wind part of the negative electrode in the electrode wound body, the innermost positive electrode wind part including the inner winding side edge, the innermost negative electrode wind part being located on an inner side relative to the innermost positive electrode wind part in the electrode wound body.
(3)

The secondary battery according to (1) or (2), in which
the separator includes, as the three or more bases, a first separator member and a second separator member, and
in the stacked structure, the first separator member, the positive electrode, the second separator member, and the negative electrode are stacked in order.
(4)

The secondary battery according to (3), in which
the first separator member includes a first inner winding side end part that is folded back in the center region of the electrode wound body and interposed between the inner winding side edge of the positive electrode and the negative electrode,
the second separator member includes a second inner winding side end part that is folded back in the center region of the electrode wound body and interposed between the inner winding side edge of the positive electrode and the negative electrode,
the first separator member includes an intermediate part other than the first inner winding side end part, the intermediate part being interposed between the inner winding side edge of the positive electrode and the negative electrode, and
the first inner winding side end part, the second inner winding side end part, and the intermediate part are included in the stacked part.
(5)

The secondary battery according to (4), in which, in an overlap part in which both the first inner winding side end part of the first separator member and the second inner winding side end part of the second separator member overlap the positive electrode, a length of the electrode wound body in a winding direction is greater than or equal to 1 millimeters and shorter than a part of the electrode wound body corresponding to an innermost one wind.
(6)

The secondary battery according to any one of (1) to (5), in which, in the positive electrode, the positive electrode current collector is covered with the positive electrode active material layer up to the inner winding side edge of the positive electrode in a winding direction of the electrode wound body.
(7)

The secondary battery according to any one of (1) to (6), in which the stacked part includes a first part interposed between the positive electrode and the negative electrode, and a second part not interposed between the positive electrode and the negative electrode, the first part having a thickness smaller than a thickness of the second part.
(8)

The secondary battery according to any one of (1) to (7), in which
the positive electrode further includes an insulating layer provided at a border between the positive electrode covered part and the positive electrode exposed part, and
the first separator member, the second separator member, or both are adhered to the insulating layer.
(9)

The secondary battery according to (8), in which the insulating layer includes a resin including polyvinylidene difluoride (PVDF).
(10)

The secondary battery according to any one of (1) to (9), in which
the separator includes, as each of the bases, a porous film including polyolefin,
the porous film has a thickness that is greater than or equal to 10 micrometers and less than or equal to 15 micrometers, and
the porous film has a surface density that is greater than or equal to 6.3 grams per square meter and less than or equal to 8.3 grams per square meter.
(11)

The secondary battery according to any one of (1) to (10), in which first edge parts of the positive electrode exposed part that is wound around the central axis are bent toward the central axis to overlap each other, the first edge parts being adjacent to each other in a radial direction of the electrode wound body.
(12)

The secondary battery according to (11), in which second edge parts of the negative electrode exposed part that is wound around the central axis are bent toward the central axis to overlap each other, the second edge parts being adjacent to each other in the radial direction.
(13)

The secondary battery according to any one of (1) to (12), in which the negative electrode active material layer includes a negative electrode active material including at least one of silicon, silicon oxide, a carbon-silicon compound, or a silicon alloy.
(14)

The secondary battery according to any one of (1) to (13), in which the positive electrode active material layer includes a positive electrode active material including at least one of lithium cobalt oxide, lithium nickel cobalt manganese oxide, or lithium nickel cobalt aluminum oxide.
(15)

A battery pack including:
the secondary battery according to any one of (1) to (14);
a controller configured to control the secondary battery; and
an outer package body containing the secondary battery.
(16)

An electric vehicle including:
the secondary battery according to any one of (1) to (14);
a converter configured to convert electric power suppled from the secondary battery into a driving force;
a drive unit configured to perform driving in accordance with the driving force; and
a controller configured to control operation of the secondary battery.
(17)

An electric aircraft including:
the battery pack according to (15);
a plurality of rotary wings;
a motor configured to rotate each of the rotary wings;
a support shaft supporting each of the rotary wings and the motor;
a motor controller configured to control rotation of the motor; and
an electric power supply line configured to supply electric power to the motor,
in which the battery pack is coupled to the electric power supply line.
(18)

An electric tool including:
the secondary battery according to any one of (1) to (14); and
a movable unit configured to receive electric power from the secondary battery.
(19)

Electronic equipment including
the secondary battery according to any one of (1) to (14) as an electric power supply source.

According to a secondary battery of an embodiment of the present disclosure, a stacked part of a separator is interposed at a position corresponding to a step at which an inner winding side edge of a positive electrode and a negative electrode overlap each other. This makes it possible to avoid damage to the separator even when a local stress resulting from the step is applied to the separator. Accordingly, it is possible to effectively prevent a short circuit, and it is thus possible to achieve higher reliability.

Note that effects of an embodiment of the present technology are not necessarily limited to those described herein and may include any of a series of effects described in relation to the example embodiments of the present technology.

Although the present disclosure has been described hereinabove in terms of the example embodiment and modification examples, the present disclosure is not limited thereto. It should be appreciated that variations may be made in the described example embodiment and modification examples by those skilled in the art without departing from the scope of the present disclosure as defined by the following claims. The limitations in the claims are to be interpreted broadly based on the language employed in the claims and not limited to examples described in this specification or during the prosecution of the application, and the examples are to be construed as non-exclusive. The use of the terms first, second, etc. do not denote any order or importance, but rather the terms first, second, etc. are used to distinguish one element from another. The term “substantially” and its variants are defined as being largely but not necessarily wholly what is specified as understood by one of ordinary skill in the art. The term “disposed on/provided on/formed on” and its variants as used herein refer to elements disposed directly in contact with each other or indirectly by having intervening structures therebetween. Moreover, no element or component in this disclosure is intended to be dedicated to the public regardless of whether the element or component is explicitly recited in the following claims.

What is claimed is:

1. A secondary battery comprising:
an electrode wound body including a stacked structure wound around a central axis extending in a first direction, the stacked structure including a positive electrode and a negative electrode that are stacked with a separator interposed therebetween;
a positive electrode current collector plate facing a first end face of the electrode wound body, the first end face being in the first direction;
a negative electrode current collector plate facing a second end face of the electrode wound body, the second end face being opposite to the first end face in the first direction; and
an electrolytic solution; and
a battery can containing the electrode wound body, the positive electrode current collector plate, the negative electrode current collector plate, and the electrolytic solution, wherein
the positive electrode includes a positive electrode covered part in which a positive electrode current collector is covered with a positive electrode active material layer, and a positive electrode exposed part in which the positive electrode current collector is not covered with the positive electrode active material layer and is exposed, the positive electrode exposed part being joined to the positive electrode current collector plate,
the negative electrode includes a negative electrode covered part in which a negative electrode current collector is covered with a negative electrode active material layer, and a negative electrode exposed part in which the negative electrode current collector is not covered with the negative electrode active material layer and is exposed, the negative electrode exposed part being joined to the negative electrode current collector plate,
the separator includes a stacked part in which three or more bases are stacked, at least two of the three or more bases being folded back in a center region of the electrode wound body, the center region of the electrode wound body being a region located on an inner winding side relative to an inner winding side end part of the negative electrode current collector, and
in the electrode wound body, an inner winding side edge of the positive electrode, the negative electrode, and the stacked part overlap each other.

2. The secondary battery according to claim 1, wherein the stacked part of the separator is provided between an innermost positive electrode wind part of the positive electrode and an innermost negative electrode wind part of the negative electrode in the electrode wound body, the innermost positive electrode wind part including the inner winding side edge, the innermost negative electrode wind part being located on an inner side relative to the innermost positive electrode wind part in the electrode wound body.

3. The secondary battery according to claim 1, wherein
the separator includes, as the three or more bases, a first separator member and a second separator member, and
in the stacked structure, the first separator member, the positive electrode, the second separator member, and the negative electrode are stacked in order.

4. The secondary battery according to claim 3, wherein
the first separator member includes a first inner winding side end part that is folded back in the center region of the electrode wound body and interposed between the inner winding side edge of the positive electrode and the negative electrode,
the second separator member includes a second inner winding side end part that is folded back in the center region of the electrode wound body and interposed between the inner winding side edge of the positive electrode and the negative electrode,
the first separator member includes an intermediate part other than the first inner winding side end part, the intermediate part being interposed between the inner winding side edge of the positive electrode and the negative electrode, and
the first inner winding side end part, the second inner winding side end part, and the intermediate part are included in the stacked part.

5. The secondary battery according to claim 4, wherein, in an overlap part in which both the first inner winding side end part of the first separator member and the second inner winding side end part of the second separator member overlap the positive electrode, a length of the electrode wound body in a winding direction is greater than or equal to 1 millimeters and shorter than a part of the electrode wound body corresponding to an innermost one wind.

6. The secondary battery according to claim 1, wherein, in the positive electrode, the positive electrode current collector is covered with the positive electrode active material layer up to the inner winding side edge of the positive electrode in a winding direction of the electrode wound body.

7. The secondary battery according to claim 1, wherein the stacked part includes a first part interposed between the positive electrode and the negative electrode, and a second part not interposed between the positive electrode and the negative electrode, the first part having a thickness smaller than a thickness of the second part.

8. The secondary battery according to claim 1, wherein
the positive electrode further includes an insulating layer provided at a border between the positive electrode covered part and the positive electrode exposed part, and
the first separator member, the second separator member, or both are adhered to the insulating layer.

9. The secondary battery according to claim 8, wherein the insulating layer includes a resin including polyvinylidene difluoride.

10. The secondary battery according to claim 1, wherein
the separator includes, as each of the bases, a porous film including polyolefin,
the porous film has a thickness that is greater than or equal to 10 micrometers and less than or equal to 15 micrometers, and
the porous film has a surface density that is greater than or equal to 6.3 grams per square meter and less than or equal to 8.3 grams per square meter.

11. The secondary battery according to claim 1, wherein first edge parts of the positive electrode exposed part that is wound around the central axis are bent toward the central axis to overlap each other, the first edge parts being adjacent to each other in a radial direction of the electrode wound body.

12. The secondary battery according to claim 11, wherein second edge parts of the negative electrode exposed part that is wound around the central axis are bent toward the central axis to overlap each other, the second edge parts being adjacent to each other in the radial direction.

13. The secondary battery according to claim 1, wherein the negative electrode active material layer includes a negative electrode active material including at least one of silicon, silicon oxide, a carbon-silicon compound, or a silicon alloy.

14. The secondary battery according to claim 1, wherein the positive electrode active material layer includes a positive electrode active material including at least one of lithium cobalt oxide, lithium nickel cobalt manganese oxide, or lithium nickel cobalt aluminum oxide.

15. A battery pack comprising:
the secondary battery according to claim 1;
a controller configured to control the secondary battery; and
an outer package body containing the secondary battery.

16. An electric vehicle comprising:
the secondary battery according to claim 1;
a converter configured to convert electric power suppled from the secondary battery into a driving force;
a drive unit configured to perform driving in accordance with the driving force; and
a controller configured to control operation of the secondary battery.

17. An electric aircraft comprising:
the battery pack according to claim 15;
a plurality of rotary wings;
a motor configured to rotate each of the rotary wings;
a support shaft supporting each of the rotary wings and the motor;
a motor controller configured to control rotation of the motor; and
an electric power supply line configured to supply electric power to the motor,
in which the battery pack is coupled to the electric power supply line.

18. An electric tool comprising:
the secondary battery according to claim 1; and
a movable unit configured to receive electric power from the secondary battery.

19. Electronic equipment comprising
the secondary battery according to claim 1 as an electric power supply source.
